(19) United States
(12) Patent Application Publication
(10) Pub. No.: US 2026/0181560 A1
(43) Pub. Date: Jun. 25, 2026

(54) ELECTRONIC APPARATUS CONTROLLING UPLINK THROUGHPUT IN OVER-TEMPERATURE STATE AND OPERATING METHOD OF THE ELECTRONIC APPARATUS

(71) Applicant: SAMSUNG ELECTRONICS CO., LTD., Suwon-si (KR)

(72) Inventors: Jungsik MIN, Suwon-si (KR); Wonhyung HEO, Suwon-si (KR); Jinseong PARK, Suwon-si (KR); Seunghee SON, Suwon-si (KR); Wonsub LEE, Suwon-si (KR); Seongkyu CHOI, Suwon-si (KR); Sanghyun HAN, Suwon-si (KR); Woong HAN, Suwon-si (KR)

(21) Appl. No.: 19/542,263

(22) Filed: Feb. 17, 2026

Related U.S. Application Data
(63) Continuation of application No. PCT/KR2024/008497, filed on Jun. 20, 2024.

(30) Foreign Application Priority Data
Aug. 18, 2023 (KR) 10-2023-0108494
Sep. 8, 2023 (KR) 10-2023-0119868

(51) Int. Cl. H04W 52/28; H04B 7/0426; H04L 1/00

(52) U.S. Cl. CPC H04W 52/28; H04B 7/0426; H04L 1/0003; H04L 1/0009

(57) ABSTRACT

An electronic apparatus determines whether the electronic apparatus is in an over-temperature state, on the basis of a sensing value of a temperature sensor, while uplink (UL) multiple-input and multiple-output (MIMO) communication of a first modulation and coding scheme (MCS) level is being performed; when it is determined that the electronic apparatus is in an over-temperature state, reduces transmission power of each of antennas; compares a first UL throughput and a reference throughput of UL MIMO communication of a second MCS level received from a base station; when the reference throughput is equal to or greater than the first UL throughput, deactivates a transmission path of an antenna having a relatively high transmission power among the antennas; and increases the reduced transmission power of the remaining antennas except for the antenna having a relatively high transmission power among the antennas.

### CROSS-REFERENCE TO RELATED APPLICATIONS

This application is a continuation application, under 35 U.S.C. § 111(a), of International Patent Application No. PCT/KR2024/008497, filed on Jun. 20, 2024, which claims priority to Korean Patent Application No. 10-2023-0108494, filed on Aug. 18, 2023 and Korean Patent Application No. 10-2023-0119868, filed on Sep. 8, 2023, the contents of which in their entirety are herein incorporated by reference.

### BACKGROUND ART

### 1. Field

Various embodiments relate to an electronic apparatus for controlling uplink (UL) throughput in an over-temperature state and an operating method of the electronic apparatus.

### 2. Description of the Related Art

In long-term evolution (LTE), uplink (UL) multiple-input and multiple-output (MIMO) may support a plurality of layers. For example, LTE UL 2×2 MIMO may support two layers. In LTE UL 2×2 MIMO, a base station may set different modulation and coding scheme (MCS) levels for each of the two layers. In LTE UL 2×2 MIMO, each layer may have its own MCS level, so even when the transmission power of one layer is adjusted, the other layer's MCS level may remain unaffected. When an electronic apparatus is in an over-temperature state in LTE UL 2×2 MIMO, the electronic apparatus may back off the transmission power of one layer to alleviate the over-temperature state. The MCS level of the layer of which transmission power is backed off may be set independently of the MCS level of the other layer. In LTE UL, the electronic apparatus may alleviate the over-temperature state while minimizing reduction of LTE UL throughput.

### SUMMARY

For new radio (NR) uplink (UL) multiple-input and multiple-output (MIMO), one modulation and coding scheme (MCS) level may be set for one to four layers, and one MCS level or two different MCS levels may be set for five to eight layers. For NR UL 2×2 MIMO supporting two layers, the two layers may have the same MCS level. In NR UL 2×2 MIMO, when an electronic apparatus in an over-temperature state simply reduces the number of layers for heat generation control, a loss in terms of UL throughput may occur. A technology that allows the electronic apparatus in the over-temperature state in NR UL 2×2 MIMO to adjust the transmission power of each of the two layers while minimizing a decrease in NR UL throughput may be desired.

In an embodiment, in NR UL MIMO (e.g., NR UL 2×2 MIMO), when an electronic apparatus is in an over-temperature state, the electronic apparatus may be provided that may maintain NR UL MIMO as much as possible (or minimize a decrease in NR UL throughput) while lowering the heat of the electronic apparatus without simply reducing the number of transmission layers.

In an embodiment, an electronic apparatus includes antennas, a temperature sensor, memory storing instructions, and at least one processor including processing circuitry. The instructions, when executed by the at least one processor, may cause the electronic apparatus to perform, in a state in which UL MIMO communication at a first MCS level is performed, an operation of determining, based on a sensing value of the temperature sensor, whether the electronic apparatus is in an over-temperature state, when it is determined that the electronic apparatus is in the over-temperature state, an operation of reducing transmission power of each of the antennas, an operation of comparing reference throughput with first UL throughput of UL MIMO communication at a second MCS level received from a base station, when the reference throughput is greater than or equal to the first UL throughput, an operation of deactivating a transmission path of an antenna having higher transmission power than transmission power of a remaining (the other) antenna of the antennas, and an operation of increasing reduced transmission power of a remaining antenna other than the antenna having the higher transmission power. The reference throughput may be determined, for example, based on UL throughput of UL MIMO communication performed by the electronic apparatus after a modulation scheme is changed from a first modulation scheme (e.g., 256-quadrature amplitude modulation (256-QAM)) to a second modulation scheme (e.g., 64-QAM) or based on UL throughput of UL MIMO communication (e.g., UL MIMO communication performed at a predetermined MCS level (e.g., an MCS level of 64-QAM)) performed by the electronic apparatus after detecting an over-temperature state.

In an embodiment an electronic apparatus includes antennas, a temperature sensor, memory storing instructions, and at least one processor including processing circuitry. The instructions, when executed by the at least one processor, may cause the electronic apparatus to perform, in a state in which UL MIMO communication at a first MCS level is performed through transmission layers corresponding to the antennas, an operation of determining, based on a sensing value of the temperature sensor, whether the electronic apparatus is in an over-temperature state, when it is determined that the electronic apparatus is in the over-temperature state, an operation of reducing transmission power of each of the transmission layers, an operation of comparing reference throughput with first UL throughput of UL MIMO communication at a second MCS level received from a base station, and when the reference throughput is greater than or equal to the first UL throughput, an operation of reducing a number of transmission layers and increasing reduced transmission power of a remaining transmission layer.

In an embodiment, an operating method of an electronic apparatus includes, in a state in which UL MIMO communication at a first MCS level is performed, based on a sensing value of one or more temperature sensors of the electronic apparatus, determining whether the electronic apparatus is in an over-temperature state, when it is determined that the electronic apparatus is in the over-temperature state, reducing transmission power of each of antennas of the electronic apparatus, comparing reference throughput with first UL throughput of UL MIMO communication at a second MCS level received from a base station, when the reference throughput is greater than or equal to the first UL throughput, deactivating a transmission path of an antenna having higher transmission power than transmission power of a remaining (the other) antenna of the antennas, and increasing reduced transmission power of a remaining antenna other than the antenna having the higher transmission power.

In an embodiment, when an electronic apparatus is in an over-temperature state in NR UL MIMO, the electronic apparatus may perform communication in a way that may obtain a gain of UL throughput by maintaining NR UL MIMO as much as possible without simply reducing the number of transmission layers.

### BRIEF DESCRIPTION OF DRAWINGS

The above and other embodiments, advantages and features of this disclosure will become more apparent by describing in further detail embodiments thereof with reference to the accompanying drawings.

FIG. 1 is a block diagram illustrating an embodiment of an electronic apparatus in a network environment.

FIGS. 2A and 2B are block diagrams of an embodiment of an electronic apparatus in a network environment including a plurality of cellular networks.

FIG. 3 is a diagram illustrating an embodiment of uplink (UL) multiple-input and multiple-output (MIMO) communication of an electronic apparatus.

FIG. 4 is a block diagram illustrating an embodiment of a configuration of an electronic apparatus.

FIG. 5 is a flowchart illustrating an embodiment of an operating method of an electronic apparatus.

FIG. 6 is a diagram illustrating an embodiment of UL MIMO communication of an electronic apparatus.

FIG. 7 is a diagram illustrating an embodiment of UL communication of an electronic apparatus.

FIG. 8 is a flowchart illustrating an embodiment of an operating method of an electronic apparatus.

FIG. 9 is a flowchart illustrating an embodiment of an operating method of an electronic apparatus.

### DETAILED DESCRIPTION

Hereinafter, embodiments are described in detail with reference to the accompanying drawings. When describing the embodiments with reference to the accompanying drawings, like reference numerals refer to like components and a repeated description related thereto will be omitted.

It will be understood that when an element is referred to as being “on” another element, it may be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” may therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” may, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term such as “about” may mean within one or more standard deviations, or within ±30%, 20%, 10%, 5% of the stated value, for example.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

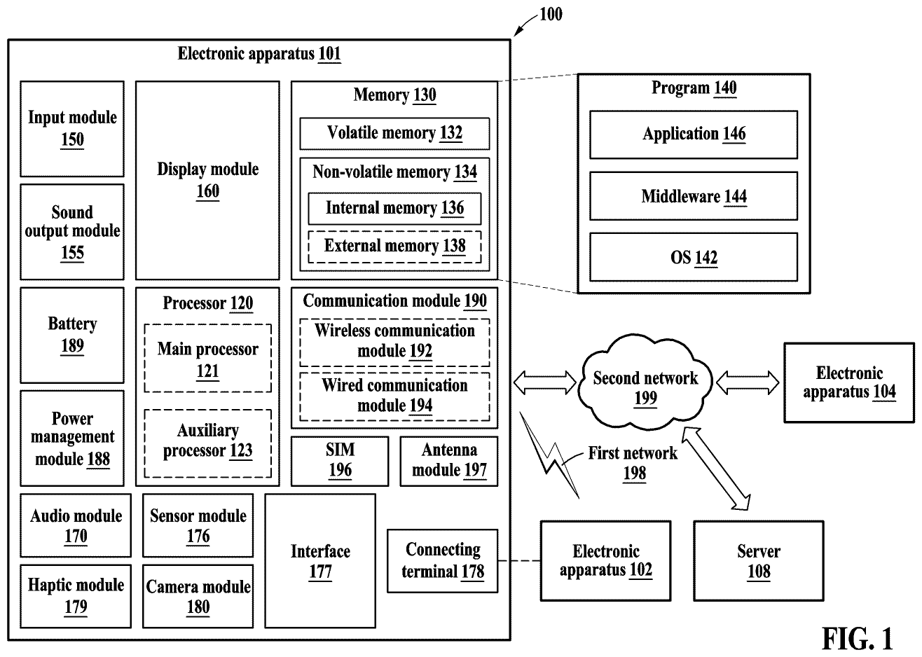

FIG. 1 is a block diagram illustrating an embodiment of an electronic apparatus 101 in a network environment 100. Referring to FIG. 1, the electronic apparatus 101 in the network environment 100 may communicate with an electronic apparatus 102 via a first network 198 (e.g., a short-range wireless communication network), or at least one of an electronic apparatus 104 or a server 108 via a second network 199 (e.g., a long-range wireless communication network). In an embodiment, the electronic apparatus 101 may communicate with the electronic apparatus 104 via the server 108. In an embodiment, the electronic apparatus 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic apparatus 101, or one or more other components may be added to the electronic apparatus 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic apparatus 101 coupled with the processor 120, and may perform various data processing or computation. In an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. In an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. In an embodiment, when the electronic apparatus 101 includes the main processor 121 and the auxiliary processor 123, the auxiliary processor 123 may be adapted to consume less power than the main processor 121, or to be predetermined to a specified function, for example. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic apparatus 101, instead of the main processor 121 while the main processor 121 is in an inactive (e.g., sleep) state, or together with the main processor 121 while the main processor 121 is in an active state (e.g., executing an application). In an embodiment, the auxiliary processor 123 (e.g., an ISP or a CP) may be implemented as part of another component (e.g., the camera module 180 or the communication module 190) functionally related to the auxiliary processor 123. In an embodiment, the auxiliary processor 123 (e.g., an NPU) may include a hardware structure specified for artificial intelligence model processing. An artificial intelligence model may be generated by machine learning. Such learning may be performed, e.g., by the electronic apparatus 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic apparatus 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic apparatus 101, from the outside (e.g., a user) of the electronic apparatus 101. The input module 150 may include, for example, a microphone, a mouse, a keyboard, a key (e.g., a button), or a digital pen (e.g., a stylus pen).

The sound output module 155 may output sound signals to the outside of the electronic apparatus 101. The sound output module 155 may include, for example, a speaker or a receiver. The speaker may be used for general purposes, such as playing multimedia or playing record. The receiver may be used for receiving incoming calls. In an embodiment, the receiver may be implemented as separate form, or as part of the speaker.

The display module 160 may visually provide information to the outside (e.g., a user) of the electronic apparatus 101. The display module 160 may include, for example, a display, a hologram device, or a projector and control circuitry to control a corresponding one of the display, hologram device, and projector. In an embodiment, the display module 160 may include a touch sensor adapted to detect a touch, or a pressure sensor adapted to measure the intensity of force incurred by the touch.

The audio module 170 may convert a sound into an electrical signal and vice versa. In an embodiment, the audio module 170 may obtain the sound via the input module 150, or output the sound via the sound output module 155 or an external electronic apparatus (e.g., the electronic apparatus 102 such as a speaker or headphones) directly or wirelessly connected to the electronic apparatus 101.

The sensor module 176 may detect an operational state (e.g., power or temperature) of the electronic apparatus 101 or an environmental state (e.g., a state of a user) external to the electronic apparatus 101, and then generate an electrical signal or data value corresponding to the detected state. In an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic apparatus 101 to be coupled with the external electronic apparatus (e.g., the electronic apparatus 102) directly (e.g., wiredly) or wirelessly. In an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic apparatus 101 may be physically connected with the external electronic apparatus (e.g., the electronic apparatus 102). In an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. In an embodiment, the haptic module 179 may include, for example, a motor, a piezoelectric element, or an electric stimulator.

The camera module 180 may capture a still image and moving images. In an embodiment, the camera module 180 may include one or more lenses, image sensors, ISPs, or flashes.

The power management module 188 may manage power supplied to the electronic apparatus 101. In an embodiment, the power management module 188 may be implemented as at least part of, for example, a power management integrated circuit (PMIC).

The battery 189 may supply power to at least one component of the electronic apparatus 101. In an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic apparatus 101 and the external electronic apparatus (e.g., the electronic apparatus 102, the electronic apparatus 104, or the server 108) and performing communication via the established communication channel. The communication module 190 may include one or more CPs that are operable independently from the processor 120 (e.g., the AP) and support a direct (e.g., wired) communication or a wireless communication. In an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic apparatus 104 via the first network 198 (e.g., a short-range communication network, such as Bluetooth™, wireless-fidelity (Wi-Fi) direct, or IR data association (IrDA)) or the second network 199 (e.g., a long-range communication network, such as a legacy cellular network, a fifth generation (5G) network, a next-generation communication network, the Internet, or a computer network (e.g., LAN or a wide area network (WAN)). These various types of communication modules may be implemented as a single component (e.g., a single chip), or may be implemented as multiple components (e.g., multiple chips) separate from each other. The wireless communication module 192 may identify and authenticate the electronic apparatus 101 in a communication network, such as the first network 198 or the second network 199, using subscriber information (e.g., international mobile subscriber identity (IMSI)) stored in the SIM 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a relatively high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or relatively large scale antenna. The wireless communication module 192 may support various requirements specified in the electronic apparatus 101, an external electronic apparatus (e.g., the electronic apparatus 104), or a network system (e.g., the second network 199). In an embodiment, the wireless communication module 192 may support a peak data rate (e.g., 20 gigabits per second (Gbps) or more) for implementing eMBB, loss coverage (e.g., 164 decibels (dB) or less) for implementing mMTC, or U-plane latency (e.g., 0.5 millisecond (ms) or less for each of downlink (DL) and uplink (UL), or a round trip of 1 ms or less) for implementing URLLC.

The antenna module 197 may transmit or receive a signal or power to or from the outside (e.g., the external electronic apparatus) of the electronic apparatus 101. In an embodiment, the antenna module 197 may include an antenna including a radiating element composed of a conductive material or a conductive pattern formed in or on a substrate (e.g., a printed circuit board (PCB)). In an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or power may then be transmitted or received between the communication module 190 and the external electronic apparatus via the selected at least one antenna. In an embodiment, another component (e.g., a radio frequency integrated circuit (RFIC)) other than the radiating element may be additionally formed as a part of the antenna module 197.

In embodiments, the antenna module 197 may form a mmWave antenna module. In an embodiment, the mm Wave antenna module may include a PCB, an RFIC disposed on a first surface (e.g., the bottom surface) of the PCB or next (adjacent) to the first surface and capable of supporting a designated high-frequency band (e.g., the mm Wave band), and a plurality of antennas (e.g., array antennas) disposed on a second surface (e.g., the top or a side surface) of the PCB, or next (adjacent) to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

In an embodiment, commands or data may be transmitted or received between the electronic apparatus 101 and the external electronic apparatus 104 via the server 108 coupled with the second network 199. Each of the external electronic apparatuses 102 and 104 may be a device of a same type as, or a different type, from the electronic apparatus 101. In an embodiment, all or some of operations to be executed at the electronic apparatus 101 may be executed at one or more of the external electronic apparatuses 102, 104, or 108. In an embodiment, when the electronic apparatus 101 should perform a function or a service automatically, or in response to a request from a user or another device, the electronic apparatus 101, instead of, or in addition to, executing the function or the service, may request the one or more external electronic apparatuses to perform at least part of the function or the service, for example. The one or more external electronic apparatuses receiving the request may perform the at least part of the function or the service requested, or an additional function or an additional service related to the request, and transfer an outcome of the performing to the electronic apparatus 101. The electronic apparatus 101 may provide the outcome, with or without further processing of the outcome, as at least part of a reply to the request. To that end, cloud computing, distributed computing, mobile edge computing (MEC), or client-server computing technology may be used, for example. The electronic apparatus 101 may provide ultra-low-latency services using, e.g., distributed computing or MEC. In another embodiment, the external electronic apparatus 104 may include an Internet-of-Things (IoT) device. The server 108 may be an intelligent server using machine learning and/or a neural network. In an embodiment, the external electronic apparatus 104 or the server 108 may be included in the second network 199. The electronic apparatus 101 may be applied to intelligent services (e.g., smart home, smart city, smart car, or healthcare) based on 5G communication technology or IoT-related technology.

The electronic apparatus in various embodiments may be one of various types of electronic apparatuses. The electronic apparatus may include, for example, a portable communication device (e.g., a smartphone), a computer device, a portable multimedia device, a portable medical device, a camera, a wearable device, or a home appliance. In an embodiment of the disclosure, the electronic apparatuses are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms such as “1st” and “2nd,” or “first” and “second” may be used to simply distinguish a corresponding component from another, and do not limit the components in other feature (e.g., importance or order). It is to be understood that when an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware and may interchangeably be used with other terms, for example, “logic,” “logic block,” “part,” or “circuitry.” A module may be a single integral component, or a minimum unit or part thereof, adapted to perform one or more functions. In an embodiment, the module may be implemented in a form of an application-specific integrated circuit (ASIC), for example.

Various embodiments as set forth herein may be implemented as software (e.g., the program 140) including one or more instructions that are stored in a storage medium (e.g., internal memory 136 or external memory 138) that is readable by a machine (e.g., the electronic apparatus 101). In an embodiment, a processor (e.g., the processor 120) of the machine (e.g., the electronic apparatus 101) may invoke at least one of the one or more instructions stored in the storage medium and execute it, for example. This allows the machine to be operated to perform at least one function according to the at least one instruction invoked. The one or more instructions may include code generated by a compiler or code executable by an interpreter. A machine-readable storage medium may be provided in the form of a non-transitory storage medium. The term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

In an embodiment, a method according to the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smartphones) directly. When distributed online, at least part of the computer program product may be temporarily generated or at least temporarily stored in the machine-readable storage medium, such as memory of the manufacturer's server, a server of the application store, or a relay server.

In various embodiments, each component (e.g., a module or a program) of the above-described components may include a single entity or multiple entities, and some of the multiple entities may be separately disposed in different components. In various embodiments, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. In various embodiments, operations performed by the module, the program, or another component may be carried out sequentially, in parallel, repeatedly, or heuristically, or one or more of the operations may be executed in a different order or omitted, or one or more other operations may be added.

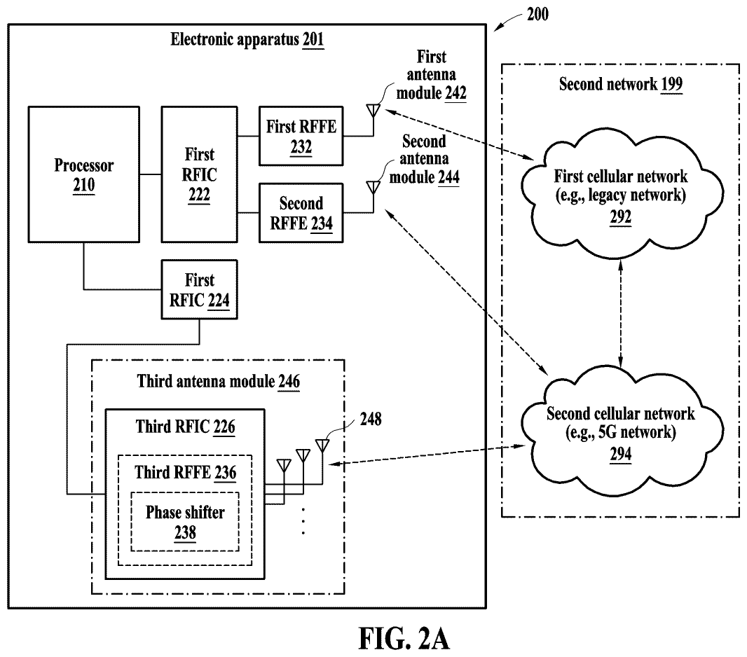

FIGS. 2A and 2B are block diagrams of an embodiment of the electronic apparatus 201 in a network environment 200 including a plurality of cellular networks.

Referring to FIG. 2A, the electronic apparatus 201 may include a processor 210 (e.g., the processor 120 or CP of FIG. 1), a first RFIC 222, a second RFIC 224, a first radio frequency front end (RFFE) 232, a second RFFE 234, a first antenna module 242, a second antenna module 244, and a third antenna module 246. The second network 199 may include a first cellular network 292 (e.g., a legacy network) and a second cellular network 294 (e.g., a 5G network). The electronic apparatus 201 may further include at least one of the components described with reference to FIG. 1, and the second network 199 may further include at least one another network. In an embodiment, the second RFIC 224 may be omitted or may be included as a portion of a third RFIC 226.

In an embodiment, the first RFIC 222, the second RFIC 224, the first RFFE 232, and the second RFFE 234 of FIG. 2A may be included in the communication module 190 (e.g., the wireless communication module 192) of FIG. 1, and a first antenna module 242, a second antenna module 244, and a third antenna module 246 of FIG. 2A may be included in the antenna module 197 of FIG. 1.

In an embodiment, the processor 210 may establish a communication channel of a band to be used for wireless communication with the first cellular network 292 and support legacy network communication through the established communication channel. The first cellular network 292 may be, for example, a legacy network including a second generation (2G) network, a third generation (3G) network, a 4G network, or a long-term evolution (LTE) network. The processor 210 may establish a communication channel corresponding to a first band (e.g., about 6 gigahertz (GHz) to about 60 GHz) (or a 5G standard frequency range (FR) 2 (e.g., 24.25 GHz to 52.6 GHz)) among bands to be used for wireless communication with the second cellular network 294 and may support 5G network communication through the established communication channel. The second cellular network 294 may be a 5G network defined by a third generation partnership project (3GPP). The processor 210 may establish a communication channel corresponding to a second band (e.g., approximately less than or equal to 6 GHz) (or a 5G standard FR1 (e.g., 410 megahertz (MHz) to 7.125 GHz) of bands to be used for wireless communication with the second cellular network 294 and may support 5G network communication through the established communication channel.

In an embodiment, during transmission, the first RFIC 222 may convert a baseband signal generated by the processor 210 into an RF signal of a frequency band (e.g., approximately 700 MHz to approximately 3 GHz) used by the first cellular network 292. During reception, the RF signal may be received or obtained from the first cellular network 292 through the first antenna module 242 and may be preprocessed through the first RFFE 232. The first RFIC 222 may convert the preprocessed RF signal into a baseband signal to be processed by the processor 210.

In an embodiment, during transmission, the first RFIC 222 may convert the baseband signal generated by the processor 210 into an RF signal (hereinafter, also referred to as a 5G Sub6 RF signal) in a Sub6 band (e.g., approximately less than or equal to 6 GHz) used by the second cellular network 294. During reception, the 5G Sub6 RF signal may be received or obtained from the second cellular network 294 via the second antenna module 244 and may be preprocessed through the second RFFE 234. The first RFIC 222 may convert the preprocessed 5G Sub6 RF signal into a baseband signal that may be processed by the processor 210.

In an embodiment, the third RFIC 226 may convert a baseband signal generated by the processor 210 into an RF signal (hereinafter, also referred to as a 5G Above6 RF signal) in a 5G Above6 band (e.g., approximately 6 GHz to approximately 60 GHz) to be used by the second cellular network 294. During reception, the 5G Above6 RF signal may be received or obtained from the second cellular network 294 via the third antenna module 246 (e.g., an antenna 248) and may be preprocessed through the third RFFE 236. The third RFIC 226 may convert the preprocessed 5G Above6 RF signal into a baseband signal that may be processed by the processor 210. In an embodiment, the third RFFE 236 may be formed as a portion of the third RFIC 226.

In an embodiment, the electronic apparatus 201 may include the second RFIC 224 separately from the third RFIC 226 or as at least a portion of the third RFIC 226. In this case, the second RFIC 224 may convert the baseband signal generated by the processor 210 into an RF signal (hereinafter, also referred to as an IF signal) of an intermediate frequency band (e.g., approximately 9 GHz to 11 GHz) and may transmit the IF signal to the third RFIC 226. The third RFIC 226 may convert the IF signal into a 5G Above6 RF signal. During reception, the 5G Above6 RF signal may be received or obtained from the second cellular network 294 via the third antenna module 246 (e.g., the antenna 248) and may be converted into an IF signal by the third RFIC 226. The second RFIC 224 may convert the IF signal into a baseband signal that may be processed by the processor 210.

In an embodiment, at least one of the first antenna module 242 or the second antenna module 244 may be omitted or combined with another antenna module to process RF signals of a plurality of corresponding bands.

In an embodiment, the third RFIC 226 and the antenna 248 may be disposed on the same substrate to form the third antenna module 246. In an embodiment, the processor 120 may be disposed on a first substrate (e.g., a main PCB), for example. In this case, the third RFIC 226 may be disposed on a partial area (e.g., a bottom surface) of a second substrate (e.g., a sub PCB) separate from the first substrate, and the antenna 248 may be disposed on another partial area (e.g., a top surface) of the second substrate (e.g., the sub PCB), to form the third antenna module 246. By disposing the third RFIC 226 and the antenna 248 on the same substrate, it may be possible to reduce a length of a transmission line therebetween. This may reduce, for example, the loss (e.g., attenuation) of a signal in a relatively high frequency band (e.g., approximately 6 GHz to 60 GHz) used for 5G network communication due to a transmission line. Thus, the electronic apparatus 201 may enhance the quality or speed of communication with the second cellular network 294 (e.g., a 5G network).

In an embodiment, the antenna 248 may be formed as an antenna array including a plurality of antenna elements that may be used for beamforming. In this case, the third RFIC 226 may include, for example, a plurality of phase shifters 238 corresponding to the plurality of antenna elements as a portion of the third RFFE 236. During transmission, each of the plurality of phase shifters 238 may convert a phase of a 5G Above6 RF signal to be transmitted to the outside (e.g., a base station of a 5G network) of the electronic apparatus 201 through a corresponding antenna element. During reception, each of the plurality of phase shifters 238 may convert a phase of a 5G Above6 RF signal received from the outside (e.g., the base station of the 5G network) through the corresponding antenna element into the same or substantially the same phase. This may enable transmission or reception through beamforming between the electronic apparatus 201 and the outside.

The second cellular network 294 may be operated independently of the first cellular network 292 (e.g., standalone (SA)) or in connection to the first cellular network 292 (e.g., non-standalone (NSA)). In an embodiment, a 5G network may include only an access network (e.g., a 5G radio access network (RAN) or a next generation RAN (NG RAN)) and may not include a core network (e.g., a next generation core (NGC)), for example. In this case, after accessing an access network of the 5G network, the electronic apparatus 201 may access an external network (e.g., the Internet) under a control of a core network (e.g., an evolved packet core (EPC)) of a legacy network. Protocol information (e.g., LTE protocol information) for communication with a legacy network or protocol information (e.g., NR protocol information) for communication with the 5G network may be stored in memory (e.g., the memory 130 of FIG. 1) to be accessed by the processor 210.

In the example illustrated in FIG. 2A, the first RFIC 222 may support both a frequency band used in the first cellular network 292 and a Sub6 band. The disclosure is not limited thereto, and each of the separate RFICs may support each of the frequency band used in the first cellular network 292 and the Sub6 band, as illustrated in the example in FIG. 2B. In the example illustrated in FIG. 2B, during transmission, a (1-1)-th RFIC 222-1 may convert a baseband signal generated by the processor 210 into an RF signal of the frequency band used in the first cellular network 292. During reception, the RF signal may be received or obtained from the first cellular network 292 via the first antenna module 242 and preprocessed via the first RFFE 232. The (1-1)-th RFIC 222-1 may convert the preprocessed RF signal into a baseband signal so that the RF signal may be processed by the processor 210. During transmission, a (1-2)-th RFIC 222-2 may convert the baseband signal generated by the processor 210 into a 5G Sub6 RF signal. During reception, the 5G Sub6 RF signal may be received or obtained from the second cellular network 294 via the second antenna module 244 and may be preprocessed through the second RFFE 234. The (1-2)-th RFIC 222-2 may convert the preprocessed 5G Sub6 RF signal into a baseband signal so that the 5G Sub6 RF signal may be processed by the processor 210.

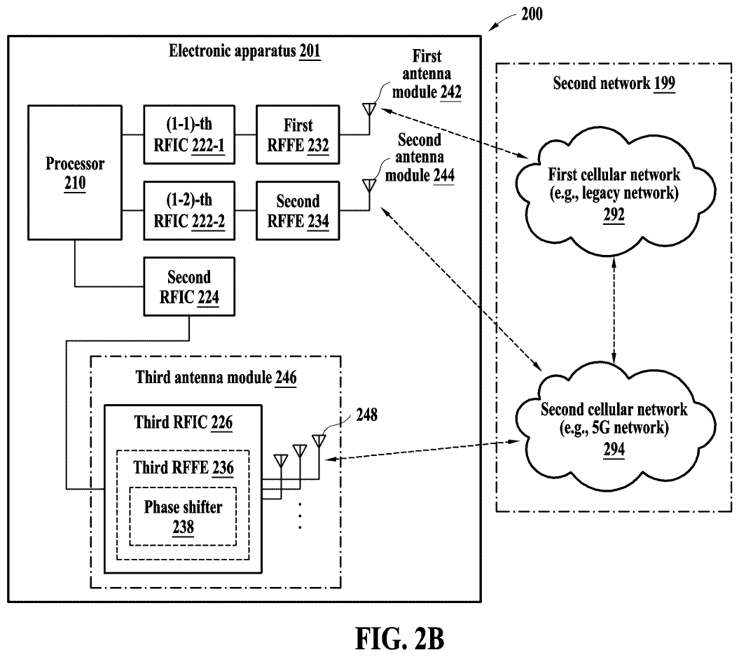

FIG. 3 is a diagram illustrating an embodiment of uplink multiple-input and multiple-output communication of an electronic apparatus.

In an embodiment, an electronic apparatus 301 may perform M×N UL MIMO communication (e.g., NR M×N UL MIMO communication) with a base station 321 (e.g., an NR base station). The NR M×N UL MIMO communication may be, for example, M×N UL MIMO communication in an NR frequency band (e.g., FR1 or FR2). M may represent the number of antennas (e.g., NR antennas) of a transmitter (e.g., the electronic apparatus 301), and N may represent the number of antennas (e.g., NR antennas) of a receiver (e.g., the base station 321). An operation of the electronic apparatus 301 in 2×2 UL MIMO (e.g., NR 2×2 UL MIMO) is described with reference to FIG. 3. The embodiments described with reference to FIG. 3 may apply to M×N UL MIMO.

In an embodiment, in 2×2 UL MIMO, the electronic apparatus 301 may utilize transmission layers (e.g., a first transmission layer and a second transmission layer). A transmission layer may be, for example, a path (or an independent channel between each of the antennas 311 and 312 of the electronic apparatus 301 and each of the antennas 331 and 332 of the base station 321) along which the electronic apparatus 301 transmits a signal to the base station 321. In the example illustrated in FIG. 3, the first transmission layer may be, for example, a path along which the electronic apparatus 301 transmits a signal to the base station 321 via the antenna 311. The second transmission layer may be, for example, a path along which the electronic apparatus 301 transmits a signal to the base station 321 via the antenna 312. For 4×4 UL MIMO (e.g., NR 4×4 UL MIMO), the number of transmission layers (or transmission paths) may be, for example, 4.

In the example illustrated in FIG. 3, the electronic apparatus 301 may include a plurality of antennas 311 and 312, and the base station 321 may include a plurality of antennas 331 and 332.

In an embodiment, each of the antennas 311 and 312 of the electronic apparatus 301 may be, for example, an NR antenna, and each of the antennas 331 and 332 of the base station 321 may be, for example, an NR antenna. An NR antenna may be an antenna used to transmit and/or receive a signal in an NR frequency band (e.g., FR1 or FR2), for example. The disclosure is not limited thereto, and an NR antenna may transmit and/or receive a signal in an NR band and may transmit and/or receive a signal in an LTE band.

In an embodiment, the electronic apparatus 301 may transmit a reference signal (e.g., a sounding reference signal (SRS) or a demodulate reference signal (DMRS)) to the base station 321 via at least one of the plurality of antennas 311 and 312. The base station 321 may receive a reference signal from the electronic apparatus 301 and estimate a channel between the electronic apparatus 301 and the base station 321 from the received reference signal. In an embodiment, the electronic apparatus 301 may transmit the reference signal to the base station 321 via the plurality of antennas 311 and 312, and the base station 321 may receive the reference signal from the electronic apparatus 301 via the plurality of antennas 331 and 332, for example. The base station 321 may estimate a channel between the antenna 311 of the electronic apparatus 301 and the antenna 331 of the base station 321 and may estimate a channel between the antenna 312 of the electronic apparatus 301 and the antenna 332 of the base station 321. Based on channel estimation, the base station 321 may determine a modulation and coding scheme (MCS) level (or MCS index) for UL MIMO communication (or each of the transmission layers) of the electronic apparatus 301. The base station 321 may transmit downlink control information (DCI) including the determined MCS level to the electronic apparatus 301.

In an embodiment, for NR UL MIMO, the base station 321 may determine (or set) the MCS level of each transmission layer to be the same. In an embodiment, for NR 2×2 UL MIMO, the base station 321 may determine that the MCS level of the first transmission layer is the same as the MCS level of the second transmission layer, for example.

In an embodiment, the electronic apparatus 301 may check a modulation scheme (e.g., 256-quadrature amplitude modulation (QAM), 64-QAM, 16-QAM, and quadrature phase shift keying (QPSK)) and an encoding scheme (e.g., low-density parity check (LDPC)) through the MCS level received from the base station 321. The electronic apparatus 301 may perform a processing operation on data to be transmitted to the base station 321 to generate a baseband signal. The processing operation may include at least one or all of, for example, channel encoding (e.g., channel encoding based on a coding scheme indicated by a received MCS level), scrambling, modulation (e.g., modulation based on a modulation scheme indicated by a received MCS level), layer mapping, antenna mapping, digital beamforming (e.g., precoding), resource element (RE) mapping, inverse fast Fourier transform (IFFT), or cyclic prefix (CP) insertion. The electronic apparatus 301 may perform RF transform on the generated baseband signal to generate a transmission signal (or UL signal) (e.g., a transmission signal in the NR band) of each of the transmission layers.

In an embodiment, the electronic apparatus 301 may transmit transmission signals (or UL signals) to the base station 321 via the antennas 311 and 312 (or transmission layers). In an embodiment, as in the example illustrated in FIG. 3, the electronic apparatus 301 may transmit a transmission signal 1 (or UL signal 1) to the base station 321 via the antenna (also referred to as a first antenna) 311 (or first transmission layer) and may transmit a transmission signal 2 (or UL signal 2) to the base station 321 via the antenna (also referred to as a second antenna) 312 (or second transmission layer), for example.

In an embodiment, the electronic apparatus 301 may perform UL communication with the base station 321 via one antenna (or one transmission layer). The electronic apparatus 301 may perform single-input single-output (SISO) UL communication with the base station 321. In an embodiment, the electronic apparatus 301 may perform a processing operation on data to be transmitted to the base station 321 to generate a baseband signal and perform RF transform on the generated baseband signal to generate a transmission signal (or UL signal) in the NR band, for example. The electronic apparatus 301 may transmit the transmission signal (or UL signal) to the base station 321 via one of the antennas 311 and 312.

In an embodiment, as an MCS level decreases, the throughput of the UL MIMO communication may decrease. Table 1 below shows embodiments of the UL throughput of 2×2 UL MIMO communication at each of MCS levels.

TABLE 1

| MCS | Modulation | 1 TX UL | 2 × 2 UL MIMO |
|---|---|---|---|
| level | scheme | throughput (Mbps) | throughput (Mbps) |
| 27 | 256-QAM | 121.30 | 242.6 |
| 26 | 256-QAM | 118.07 | 236.14 |
| 25 | 256-QAM | 114.79 | 229.58 |
| 24 | 256-QAM | 108.23 | 216.46 |
| 23 | 256-QAM | 101.67 | 203.34 |
| 22 | 256-QAM | 96.69 | 193.38 |
| 21 | 256-QAM | 91.83 | 183.66 |
| 20 | 256-QAM | 86.85 | 173.7 |
| 19 | 64-QAM | 83.59 | 167.18 |
| 18 | 64-QAM | 78.71 | 157.42 |
| 17 | 64-QAM | 73.77 | 147.54 |
| 16 | 64-QAM | 68.87 | 137.74 |
| 15 | 64-QAM | 64.00 | 128 |
| 14 | 64-QAM | 59.03 | 118.06 |
| 13 | 64-QAM | 54.12 | 108.24 |
| 12 | 64-QAM | 50.00 | 100 |
| 11 | 64-QAM | 45.06 | 90.12 |
| 10 | 16-QAM | 41.80 | 83.6 |
| 9 | 16-QAM | 39.35 | 78.7 |
| 8 | 16-QAM | 35.23 | 70.46 |
| 7 | 16-QAM | 31.16 | 62.32 |
| 6 | 16-QAM | 27.87 | 55.74 |
| 5 | 16-QAM | 24.18 | 48.36 |
| 4 | QPSK | 19.27 | 38.54 |
| 3 | QPSK | 14.34 | 28.68 |
| 2 | QPSK | 9.83 | 19.66 |

In Table 1 above, 1 TX UL throughput may be the throughput of UL communication through one transmission layer (or one transmission path). 1 TX UL throughput may be half of 2×2 UL MIMO throughput.

In an embodiment, the temperature of the electronic apparatus 301 may increase while the electronic apparatus 301 performs the UL MIMO communication (e.g., NR UL MIMO communication) with the base station 321. Factors that increase the temperature of the electronic apparatus 301 may include, for example, the transmission power of the electronic apparatus 301 (e.g., the antennas 311 and 312 or transmission layers) and/or a modulation scheme (e.g., 256-QAM, 64-QAM, 16-QAM, and QPSK) in the UL MIMO communication of the electronic apparatus 301. Table 2 below shows an embodiment of the relationship between the transmission power of the electronic apparatus 301 in NR Band 1 and the temperature (e.g., surface temperature) of the electronic apparatus 301. Table 3 below shows an embodiment of the relationship between a modulation scheme in the UL MIMO communication of the electronic apparatus 301 in NR Band 1 and the temperature (e.g., surface temperature) of the electronic apparatus 301.

TABLE 2

| Transmission power | Temperature (° C.) |
|---|---|
| dBm | |
| 0 | 35.8 |
| 2 | 36.0 |
| 4 | 36.1 |
| 6 | 36.3 |
| 8 | 36.9 |
| 10 | 37.1 |
| 12 | 37.7 |
| 14 | 39.3 |
| 16 | 40.9 |
| 18 | 42.0 |
| 20 | 41.3 |
| 21 | 41.7 |
| 22 | 43.0 |
| 23 | 44.0 |

TABLE 3

| Modulation | Temperature |
|---|---|
| scheme | (° C.) |
| QPSK | 44.0 |
| 16-QAM | 43.9 |
| 64-QAM | 43.9 |
| 256-QAM | 47.2 |

Referring to Table 2 above, as the transmission power (in terms of decibel-milliwatts (dBm)) of the electronic apparatus 301 increases, the temperature (e.g., surface temperature) of the electronic apparatus 301 may increase. Referring to Table 3 above, the temperature (e.g., surface temperature) of the electronic apparatus 301 may be the highest when the modulation scheme is 256-QAM.

In an embodiment, it may be determined whether the electronic apparatus 301 is in an over-temperature state while the electronic apparatus 301 performs the UL MIMO communication with the base station 321. An over-temperature state may be, for example, a state in which the temperature (e.g., surface temperature) of the electronic apparatus 301 is greater than or equal to a threshold temperature (e.g., 42 degrees Celsius (° C.) to 43° C.). When the electronic apparatus 301 is in the over-temperature state while performing the UL MIMO communication, transmission power (e.g., the transmission power of each of the antennas 311 and 312) may be reduced. The electronic apparatus 301 may reduce the transmission power to lower an MCS level. Accordingly, the electronic apparatus 301 may alleviate the over-temperature state while maintaining UL MIMO as much as possible.

In an embodiment, the electronic apparatus 301 may reduce the number of transmission layers of the UL MIMO communication when UL throughput is less than or equal to reference throughput while performing the UL MIMO communication at a predetermined MCS level (e.g., MCS level 9 of Table 1 above). As described below, the reference throughput may be determined, for example, based on the UL throughput of the UL MIMO communication performed by the electronic apparatus 301 after the modulation scheme is changed from a first modulation scheme (e.g., 256-QAM) to a second modulation scheme (e.g., 64-QAM). In an embodiment, the reference throughput may be determined based on the UL throughput of the UL MIMO communication (e.g., UL MIMO communication performed at a predetermined MCS level (e.g., an MCS level of 64-QAM)) performed after the electronic apparatus 301 detects the over-temperature state, for example. In an embodiment, the electronic apparatus 301 may drop a transmission layer (or transmission path) with the highest transmission power among the transmission layers (or transmission paths) of the UL MIMO communication, for example. Here, “drop” may, for example, be interpreted as referring to an unused or inactive state. The electronic apparatus 301 may not use the transmission layer (or transmission path) with the highest transmission power among the transmission layers (or transmission paths) of the UL MIMO communication. The electronic apparatus 301 may increase the transmission power of a remaining transmission layer and may increase an MCS level as the transmission power increases.

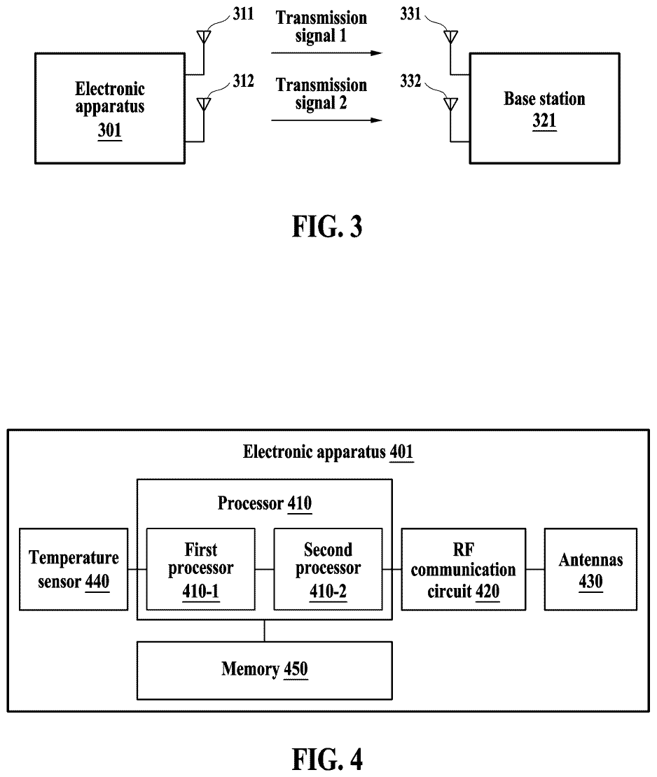

FIG. 4 is a block diagram illustrating an embodiment of a configuration of an electronic apparatus.

Referring to FIG. 4, an electronic apparatus 401 (e.g., the electronic apparatus 101 of FIG. 1, the electronic apparatus 201 of FIGS. 2A and 2B, and the electronic apparatus 301 of FIG. 3) in an embodiment may include at least one processor 410 (e.g., the processor 120 of FIG. 1 and the processor 210 of FIGS. 2A and 2B), an RF communication circuit 420, antennas 430 (e.g., the antennas 311 and 312 of FIG. 3), at least one temperature sensor 440, and memory 450 (e.g., the memory 130 of FIG. 1).

In an embodiment, the processor 410 may include a first processor 410-1 and/or a second processor 410-2.

In an embodiment, the first processor 410-1 may correspond to, for example, the main processor 121 of FIG. 1, a CPU, or an AP. The second processor 410-2 may correspond to, for example, the auxiliary processor 123 or CP of FIG. 1.

In an embodiment, the RF communication circuit 420 of FIG. 4 may include, for example, the first RFIC 222 and the second RFFE 234 of FIG. 2A. Depending on the implementation, the RF communication circuit 420 of FIG. 4 may include, for example, the (1-2)-th RFIC 222-2 and the second RFFE 234 of FIG. 2B.

In an embodiment, the antennas 430 of FIG. 4 may be included in, for example, the second antenna module 244 of FIGS. 2A and 2B. Each of the antennas 430 of FIG. 4 may be an NR antenna.

In an embodiment, the memory 450 may store instructions. The instructions, when executed by the processor 410 (e.g., the first processor 410-1 and/or the second processor 410-2), may cause the electronic apparatus 401 to perform at least some or all of the operations (e.g., the operations of the processor 410) described with reference to FIG. 4.

In an embodiment, the electronic apparatus 401 may perform UL MIMO communication through a plurality of transmission layers (or transmission paths) of UL MIMO (e.g., NR UL MIMO).

In an embodiment, the electronic apparatus 401 may receive an MCS level (e.g., one of the MCS levels in Table 1 above) from a base station (e.g., the base station 321 of FIG. 3). The processor 410 (e.g., the second processor 410-2) may check a modulation scheme and an encoding scheme from the received MCS level. The processor 410 (e.g., the second processor 410-2) may perform a processing operation on data to be transmitted to the base station to generate a baseband signal. The processing operation may include at least one or all of, for example, channel encoding (e.g., channel encoding based on a coding scheme indicated by a received MCS level), scrambling, modulation (e.g., modulation based on a modulation scheme indicated by a received MCS level), layer mapping, antenna mapping, digital beamforming (e.g., precoding), RE mapping, IFFT transform, or CP insertion. The processor 410 (e.g., the second processor 410-2) may transmit the generated baseband signal to the RF communication circuit 420.

In an embodiment, the RF communication circuit 420 may perform RF transform on the baseband signal received from the processor 410 (e.g., the second processor 410-2) to generate transmission signals (or UL signals) in the NR band. The RF communication circuit 420 may transmit the transmission signals (or UL signals) to the antennas 430. In an embodiment, the RF communication circuit 420 may transmit a transmission signal of each of the transmission layers of UL MIMO to each of the antennas 430, for example.

In an embodiment, each of the antennas 430 may receive a transmission signal from the RF communication circuit 420. Each of the antennas 430 may transmit each of the transmission signals to the base station 321 with a given transmission power.

In an embodiment, one or more temperature sensors 440 may sense or measure the internal temperature of the electronic apparatus 401 (e.g., the temperature of a component within the electronic apparatus 401). The temperature sensor 440 may sense (or measure) the internal temperature of the electronic apparatus 401 and (periodically) transmit an obtained sensing value (or temperature value) to the processor 410 (e.g., the first processor 410-1). In an embodiment, the electronic apparatus 401 may include a plurality of temperature sensors, each of which may sense or measure the temperature of each of some components within the electronic apparatus 401, for example. Components of which the temperature is sensed (measured) by the temperature sensors may include the processor 410 (e.g., the first processor 410-1 and/or the second processor 410-2), one or more power amplifiers (PAS) within the RF communication circuit 420, but the disclosure is not limited thereto. Each of the plurality of temperature sensors may sense (or measure) the temperature of each component within the electronic apparatus 401 and (periodically) transmit the obtained sensing value to the first processor 410-1.

In an embodiment, the processor 410 (e.g., the first processor 410-1) may receive a sensing value (or temperature value) from one or more temperature sensors 440 while the UL MIMO communication is performed and may determine, based on the received sensing value, whether the electronic apparatus 401 is in an over-temperature state. In an embodiment, the processor 410 (e.g., the first processor 410-1) may estimate (or calculate) the temperature (e.g., surface temperature) of the electronic apparatus 401 using the sensing value received from one or more temperature sensors 440 and determine whether the estimated temperature exceeds a threshold temperature, for example. The processor 410 (e.g., the first processor 410-1) may determine that the electronic apparatus 401 is in the over-temperature state when the estimated temperature exceeds the threshold temperature. The processor 410 (e.g., the first processor 410-1) may determine that the electronic apparatus 401 is not in the over-temperature state when the estimated temperature does not exceed the threshold temperature and may periodically monitor whether the electronic apparatus 401 is in the over-temperature state based on the sensing value received from one or more temperature sensors 440.

In an embodiment, when determining that the electronic apparatus 401 is in the over-temperature state, the processor 410 may perform heat control so that the over-temperature state of the electronic apparatus 401 may be alleviated. In an embodiment, when determining that the electronic apparatus 401 is in the over-temperature state, the first processor 410-1 may transmit information indicating that the electronic apparatus 401 is in the over-temperature state to the second processor 410-2, for example. When recognizing that the electronic apparatus 401 is in the over-temperature state based on information (e.g., information indicating that the electronic apparatus 401 is in the over-temperature state) received from the first processor 410-1, the second processor 410-2 may perform heat control so that the over-temperature state of the electronic apparatus 401 may be alleviated. In an embodiment, the second processor 410-2 may control the transmission power of each of the antennas 430 (or transmission layers) to be reduced (e.g., control the transmission power to be reduced or backed off by a predetermined value), for example. The predetermined value may include 1 dB, but the disclosure is not limited thereto. The second processor 410-2 may instruct the RF communication circuit 420 (or a separate controller) to reduce the transmission power of each of the antennas 430 (or transmission layers). Under instructions from the second processor 410-2, the RF communication circuit 420 (or a separate controller) may reduce the transmission power of each of the antennas 430 (or transmission layers).

In an embodiment, when the transmission power of each of the antennas 430 (or transmission layers) is reduced, the electronic apparatus 401 may receive a changed MCS level (or a lowered MCS level) from the base station 321.

In an embodiment, the processor 410 (e.g., the second processor 410-2) may determine that the electronic apparatus 401 is still in the over-temperature state at the changed MCS level (or the lowered MCS level). The processor 410 (e.g., the second processor 410-2) may compare the UL throughput of the UL MIMO communication at the changed MCS level (or the lowered MCS level) with reference throughput.

In an embodiment, the processor 410 (e.g., the second processor 410-2) may control the electronic apparatus 401 to reduce the transmission power of each of the antennas 430 (or transmission layers) when the UL throughput of the UL MIMO communication at the changed MCS level (or the lowered MCS level) is greater than the reference throughput. The processor 410 (e.g., the second processor 410-2) may reduce the number of transmission layers (or transmission paths) of the UL MIMO communication when the UL throughput of the UL MIMO communication at the changed MCS level (or the lowered MCS level) is less than or equal to the reference throughput and control the electronic apparatus 401 to increase the transmission power of a remaining transmission layer (or an antenna corresponding to the remaining transmission layer). In an embodiment, when the UL throughput of 2×2 UL MIMO communication is less than or equal to the reference throughput, the processor 410 (e.g., the second processor 410-2) may control the electronic apparatus 401 so that a transmission layer with the highest transmission power among the transmission layers (or transmission paths) of the 2×2 UL MIMO communication is not used and may increase the transmission power of the remaining transmission layer, for example. When the UL throughput of the 2×2 UL MIMO communication in the over-temperature state is less than or equal to the reference throughput, the electronic apparatus 401 may perform the UL communication with the base station through the remaining transmission layer rather than performing 2×2 UL MIMO by maintaining the plurality of transmission layers.

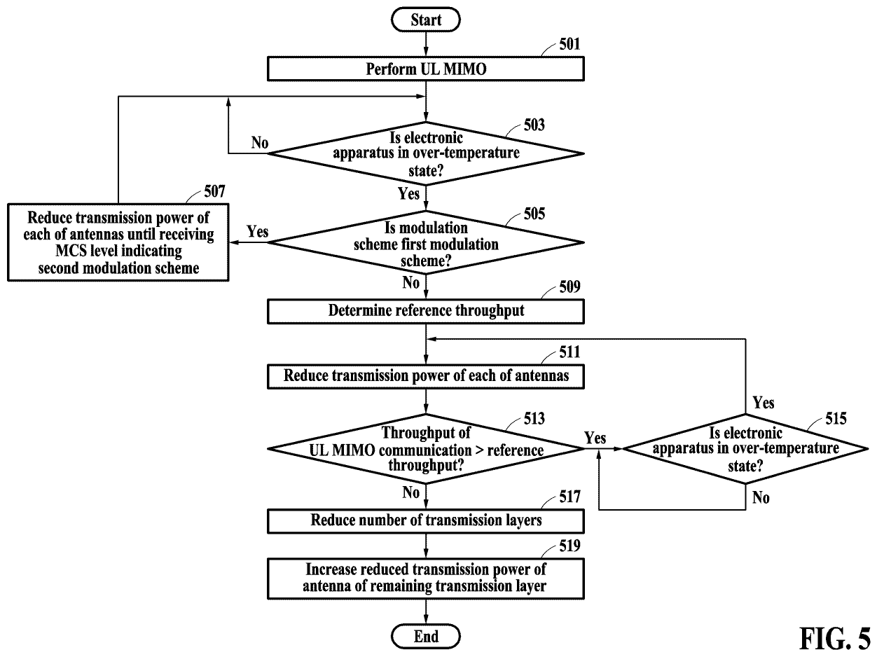

FIG. 5 is a flowchart illustrating an embodiment of an operating method of an electronic apparatus.

In operation 501, an electronic apparatus (e.g., the electronic apparatus 101 of FIG. 1, the electronic apparatus 201 of FIGS. 2A and 2B, the electronic apparatus 301 of FIG. 3, and the electronic apparatus 401 of FIG. 4) (hereinafter, also referred to as the electronic apparatus 401) may perform UL MIMO communication (e.g., 2×2 UL MIMO communication). In an embodiment, the electronic apparatus 401 may receive an MCS level (e.g., MCS level 22 of Table 1 above) from a base station (e.g., the base station 321 of FIG. 3). The electronic apparatus 401 may perform a processing operation on data to be transmitted to the base station 321 to generate a baseband signal, for example. The processing operation may include modulation according to a modulation scheme (e.g., 256-QAM) indicated by the received MCS level, but the disclosure is not limited thereto. The electronic apparatus 401 may perform RF transform on the generated baseband signal to generate a transmission signal of each of the transmission layers (e.g., each of first and second transmission layers of 2×2 UL MIMO). The electronic apparatus 401 may transmit transmission signals to the base station 321 via antennas (e.g., the antennas 311 and 312 of FIG. 3 and the antennas 430 of FIG. 4). The electronic apparatus 401 may transmit a transmission signal of each transmission layer to the base station 321 via each of the antennas 430.

In operation 503, the electronic apparatus 401 may determine whether the electronic apparatus 401 is in an over-temperature state. In an embodiment, the electronic apparatus 401 (e.g., the first processor 410-1) may estimate the temperature (e.g., surface temperature) of the electronic apparatus 401 based on a sensing value of one or more temperature sensors (e.g., one or more temperature sensors 440) (e.g., a sensing value obtained by one or more temperature sensors 440 measuring the internal temperature of the electronic apparatus 401) and may determine whether the estimated temperature exceeds a threshold temperature, for example. The electronic apparatus 401 may determine that the electronic apparatus 401 is in the over-temperature state when the estimated temperature exceeds the threshold temperature. The electronic apparatus 401 may determine that the electronic apparatus 401 is not in the over-temperature state when the estimated temperature is less than or equal to the threshold temperature.

The electronic apparatus 401 may perform operation 503 by periodically monitoring the temperature (e.g., surface temperature) of the electronic apparatus 401 when the electronic apparatus 401 is not in the over-temperature state (operation 503—No).

The electronic apparatus 401 may check whether a modulation scheme is a first modulation scheme (e.g., 256-QAM) in operation 505 when the electronic apparatus 401 is in the over-temperature state (operation 503—Yes).

The electronic apparatus 401 may reduce the transmission power of each of the antennas 430 (or transmission layers) until receiving an MCS level indicating a second modulation scheme (e.g., 64-QAM) from the base station 321 in operation 507 when the modulation scheme is the first modulation scheme (operation 505—Yes). The second modulation scheme may have a lower modulation order than that of the first modulation scheme. The electronic apparatus 401 may repeatedly perform operations 503 and 505, and transmission power reduction until the MCS level indicating the second modulation scheme (e.g., 64-QAM) is received from the base station 321.

In an embodiment, the electronic apparatus 401 may be in the over-temperature state while performing the UL MIMO communication at a given MCS level (e.g., MCS level 22 in Table 1 above), for example. In the over-temperature state, the processor 410 (e.g., the second processor 410-2) may control the transmission power of each of the antennas 430 (or transmission layers) to be repeatedly reduced (e.g., reduced by 1 dB) until the MCS level (e.g., MCS level 19 of Table 1 above) indicating the second modulation scheme (e.g., 64-QAM) is received. When the transmission power of each of the antennas 430 (or transmission layers) is reduced, the processor 410 (e.g., the second processor 410-2) may receive a changed MCS level (or a relatively low MCS level) (e.g., MCS level 21 and MCS level 20 in Table 1 above) from the base station 321. When the electronic apparatus 401 is still in the over-temperature state while performing the UL MIMO communication at the changed MCS level (e.g., MCS level 20), the processor 410 (e.g., the second processor 410-2) may control the transmission power of each of the antennas 430 (or transmission layers) to be reduced. The processor 410 (e.g., the second processor 410-2) may receive an MCS level (e.g., MCS level 19 in Table 1 above) lower than the MCS level (e.g., MCS level 20) received from the base station 321. The processor 410 (e.g., the second processor 410-2) may check or recognize that the given MCS level (or an initial MCS level at which the modulation scheme is changed from the first modulation scheme to the second modulation scheme during UL MIMO communication) (e.g., MCS level 19 in Table 1 above) indicates the second modulation scheme.

The electronic apparatus 401 may determine reference throughput in operation 509 when the modulation scheme is not the first modulation scheme (or when the modulation scheme is the second modulation scheme) (operation 505—No).

In an embodiment, the electronic apparatus 401 may determine the reference throughput based on the UL throughput of the UL MIMO communication at a given MCS level (or the initial MCS level at which the modulation scheme is changed from the first modulation scheme to the second modulation scheme during the UL MIMO communication) (e.g., MCS level 19 in Table 1 above). In an embodiment, the processor 410 (e.g., the second processor 410-2) may calculate the UL throughput of 2×2 UL MIMO communication at a given MCS level (e.g., MCS level 19 of Table 1 above) to be 167.18 megabits per second (Mbps), for example. The processor 410 (e.g., the second processor 410-2) may determine the throughput of one of the transmission layers of the 2×2 UL MIMO communication as the reference throughput or may determine a value obtained by adding an offset to the throughput of one of the transmission layers as the reference throughput. Here, the offset may be a value added to the throughput of one transmission layer to consider, for example, a block error rate (BLER). Half (e.g., 83.59 Mbps) of the UL throughput (e.g., 167.18 Mbps) of the 2×2 UL MIMO communication may correspond to the throughput of one of the transmission layers of the 2×2 UL MIMO communication. The processor 410 (e.g., the second processor 410-2) may determine, as the reference throughput, half (e.g., 83.59 Mbps) of the UL throughput (e.g., 167.18 Mbps) of the 2×2 UL MIMO communication or may determine a value obtained by adding an offset to half (e.g., 83.59 Mbps) as the reference throughput.

In an embodiment, the electronic apparatus 401 may store or record the value of the transmission power of each of the antennas 430 (or transmission layers) when the UL MIMO communication is performed (or when the reference throughput is determined) at a given MCS level (e.g., MCS level 19 of Table 1 above). In an embodiment, when the 2×2 UL MIMO communication is performed (or when the reference throughput is determined) at MCS level 19 and when the transmission power of a first antenna (e.g., the antenna 311 of FIG. 3) (or a first transmission layer) is TX power #1 and the transmission power of a second antenna (e.g., the antenna 312 of FIG. 3) (or a second transmission layer) is TX power #2, the processor 410 (e.g., the second processor 410-2) may store or record TX power #1 and TX power #2 in memory (e.g., the memory 450), for example.

In operation 511, the electronic apparatus 401 may reduce the transmission power of each of the antennas 430 (or transmission layers). To lower the temperature of the electronic apparatus 401, the second processor 410-2 may control the transmission power of each of the antennas 430 (or transmission layers) to be reduced (or backed off) by 1 dB. In an embodiment, the processor 410 (e.g., the second processor 410-2) may control the electronic apparatus 401 to reduce the transmission power of the first antenna by 1 dB from TX power #1 and may control the electronic apparatus 401 to reduce the transmission power of the second antenna by 1 dB from TX power #2, for example.

At a given MCS level (e.g., MCS level 19 in Table 1 above), the electronic apparatus 401 may perform the UL MIMO communication with each transmission power reduced by performing operation 511. When receiving, from the electronic apparatus 401, transmission signals, each of which has reduced transmission power, the base station 321 may transmit the changed MCS level (or relatively low MCS level) (e.g., an MCS level lower than MCS level 19) to the electronic apparatus 401. In an embodiment, the electronic apparatus 401 may receive the changed MCS level (e.g., MCS level 18 in Table 1 above) from the base station 321, for example. The electronic apparatus 401 may perform the UL MIMO communication at the changed MCS level (e.g., MCS level 18).

In operation 513, the electronic apparatus 401 may determine whether the throughput (or UL throughput) of the UL MIMO communication at the changed MCS level (e.g., MCS level 18 of Table 1 above) is greater than the reference throughput. In an embodiment, the processor 410 (e.g., the second processor 410-2) may calculate the UL throughput of the UL MIMO communication at the changed MCS level (e.g., MCS level 18 of Table 1 above) to be 157.42 Mbps, for example. The second processor 410-2 may determine that the calculated UL throughput (e.g., 157.42 Mbps) is greater than the reference throughput (e.g., 83.59 Mbps or 83.59+offset Mbps).

The electronic apparatus 401 may repeatedly perform operations 515, 511, and 513 when the throughput (or UL throughput) of the UL MIMO communication at the changed MCS level is greater than the reference throughput (operation 513—Yes). By repeatedly performing operation 511, the base station 321 may receive, from the electronic apparatus 401, transmission signals, each having reduced transmission power. As the transmission power of each of the transmission signals is reduced, the base station 321 may transmit, to the electronic apparatus 401, the changed MCS level (or relatively low MCS level) (e.g., an MCS level less than or equal to MCS level 17 in Table 1 above).

By repeatedly performing operations 515, 511, and 513, the electronic apparatus 401 may receive the changed MCS level (or relatively low MCS level) (e.g., MCS level 9 in Table 1 above) from the base station 321. The electronic apparatus 401 may perform the UL MIMO communication at the changed MCS level (e.g., MCS level 9 in Table 1 above). The electronic apparatus 401 may check whether the UL throughput of the UL MIMO communication at the changed MCS level (e.g., MCS level 9 in Table 1 above) is greater than the reference throughput. In an embodiment, the processor 410 (e.g., the second processor 410-2) may calculate the UL throughput of the UL MIMO communication at the changed MCS level (e.g., MCS level 9 in Table 1 above) to be 78.7 Mbps, for example. The processor 410 (e.g., the second processor 410-2) may check that the calculated throughput (e.g., 78.7 Mbps) is less than the reference throughput (e.g., 83.59 Mbps or 83.59+offset Mbps).

The electronic apparatus 401 may reduce the number of transmission layers in operation 517 when the throughput (or UL throughput) of the UL MIMO communication at the changed MCS level (e.g., MCS level 9 in Table 1 above) is less than or equal to the reference throughput (operation 513—No). In an embodiment, the processor 410 (e.g., the second processor 410-2) may control the electronic apparatus 401 so that a transmission layer having higher transmission power than transmission power of a remaining (the other) transmission layer of the transmission layers of the UL MIMO communication is not used, for example. The processor 410 (e.g., the second processor 410-2) may deactivate a transmission path having higher transmission power. When the transmission power of the first transmission layer among the first and second transmission layers of 2×2 UL MIMO is greater than the transmission power of the second transmission layer, the processor 410 (e.g., the second processor 410-2) may control the electronic apparatus 401 so that the first transmission layer is not used (or so that a transmission path corresponding to the first transmission layer is deactivated).

In operation 519, the electronic apparatus 401 may increase the reduced transmission power of an antenna of a remaining transmission layer. In an embodiment, the processor 410 (e.g., the second processor 410-2) may control the electronic apparatus 401 so that the first transmission layer among the first and second transmission layers of 2×2 UL MIMO is not used, and thus the second transmission layer may be the remaining transmission layer, for example. The processor 410 (e.g., the second processor 410-2) may control the electronic apparatus 401 to increase the reduced transmission power of the second transmission layer (or the second antenna corresponding to the second transmission layer) to a transmission power value (e.g., TX power #2) of the second transmission layer (or the second antenna) among stored transmission power values (or transmission power values stored when the reference throughput is determined) (e.g., TX power #1 and TX power #2 described above). According to this control, the transmission power of the second transmission layer (or second antenna) may be increased to TX power #2. The base station 321 may receive a transmission signal with increased transmission power through the second transmission layer. The base station 321 may transmit the changed MCS level (or increased MCS level) (e.g., an MCS level greater than or equal to MCS level 10 in Table 1 above) to the electronic apparatus 401 because the transmission power of the electronic apparatus 401 increases. The electronic apparatus 401 may perform UL communication through the second transmission layer at the changed MCS level (or increased MCS level).

In an embodiment, the electronic apparatus 401 may repeatedly reduce the transmission power of each of the transmission layers (or antennas) of the UL MIMO communication when the electronic apparatus 401 is in an over-temperature state while performing the UL MIMO communication.

In an embodiment, the electronic apparatus 401 may still be in the over-temperature state even when the transmission power of each of the transmission layers (or antennas) is repeatedly reduced. In this case, the electronic apparatus 401 may determine that performing the UL communication through a reduced number of transmission layers (e.g., one transmission layer) is more efficient in terms of UL throughput than performing the UL MIMO communication through a plurality of transmission layers by comparing the UL throughput of the UL MIMO communication with the reference throughput. Accordingly, the electronic apparatus 401 may perform the UL communication by reducing the number of transmission layers when the UL throughput of the UL MIMO communication is less than the reference throughput.

In an embodiment, the instructions, when executed by the processor 410, may cause the electronic apparatus 401 to perform at least some (or all) of the operations described with reference to FIG. 5.

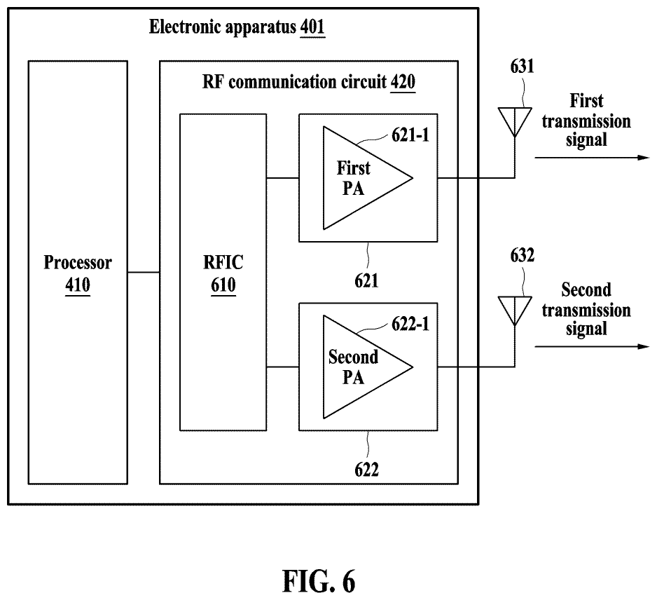

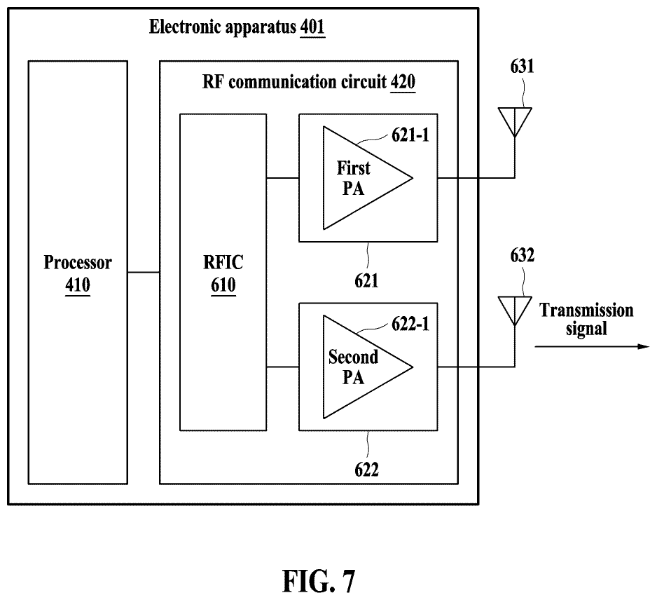

FIG. 6 is a diagram illustrating an embodiment of UL MIMO communication of an electronic apparatus. FIG. 7 is a diagram illustrating an embodiment of UL communication of an electronic apparatus.

Referring to FIGS. 6 and 7, the electronic apparatus 401 in an embodiment may include the processor 410, the RF communication circuit 420, and antennas 631 and 632 (e.g., the antennas 430 of FIG. 4).

In the examples illustrated in FIGS. 6 and 7, the RF communication circuit 420 may include an RFIC 610 (e.g., the first RFIC 222 of FIG. 2A and the (1-2)-th RFIC 222-2 of FIG. 2B) and a plurality of RFFEs 621 and 622. The RFFE 621 may include a first PA 621-1, and the RFFE 622 may include a second PA 622-1.

In an embodiment, each of the RFFE 621 and the RFFE 622 may be a separate chip or a separate integrated circuit. In an alternative embodiment, the RFFE 621 and the RFFE 622 may be implemented in one chip or one integrated circuit.

In an embodiment, each of the antennas 631 and 632 may be an NR antenna.

In an embodiment, first and second transmission layers (or first and second transmission paths) may be used in 2×2 UL MIMO of FIG. 6. The first transmission layer (or first transmission path) may include, for example, a portion of the RFIC 610, the RFFE 621, and the antenna (also referred to as a first antenna) 631, and the second transmission layer (or second transmission path) may include, for example, a portion of the RFIC 610, the RFFE 622, and the antenna (also referred to as a second antenna) 632. The processor 410 (e.g., the second processor 410-2) may generate a baseband signal (e.g., a baseband signal of the first transmission layer and a baseband signal of the second transmission layer) and transmit the generated baseband signal to the RFIC 610. The RFIC 610 may perform RF transform on the baseband signal to generate a first RF signal of the first transmission layer (e.g., a first RF signal in an NR band) and a second RF signal of the second transmission layer (e.g., a second RF signal in the NR band). The RFIC 610 may transmit the first RF signal to the RFFE 621 and the second RF signal to the RFFE 622.

In an embodiment, the RFFE 621 may amplify the received first RF signal through the first PA 621-1, and the RFFE 622 may amplify the received second RF signal through the second PA 622-1. The RFFE 621 may transmit the amplified first RF signal to the first antenna 631, and the RFFE 622 may transmit the amplified second RF signal to the second antenna 632. The first antenna 631 may transmit the amplified first RF signal as a first transmission signal to the base station 321, and the second antenna 632 may transmit the amplified second RF signal as a second transmission signal to the base station 321.

In an embodiment, in operations 507 and 511 of FIG. 5, the processor 410 (e.g., the second processor 410-2) may control the electronic apparatus 401 to reduce the transmission power of each of the antennas 631 and 632 (or transmission layers). In an embodiment, the processor 410 (e.g., the second processor 410-2) may instruct the RF communication circuit 420 (e.g., the RFFEs 621 and 622) to reduce the transmission power of each of the antennas 631 and 632 (or transmission layers), for example. The RF communication circuit 420 (e.g., the RFFE 621) may reduce a gain of the first PA 621-1 so that the transmission power of the first antenna 631 is reduced (e.g., reduced by 1 dB), and the RF communication circuit 420 (e.g., the RFFE 622) may reduce a gain of the second PA 622-1 so that the transmission power of the second antenna 632 is reduced (e.g., reduced by 1 dB). In embodiments, reducing the transmission power of each of the antennas 631 and 632 (or transmission layers) are not limited to the examples described above.

In an embodiment, in operation 517 of FIG. 5, the processor 410 (e.g., the second processor 410-2) may control the electronic apparatus 401 to reduce the number of transmission layers. The processor 410 (e.g., the second processor 410-2) may control the electronic apparatus 401 so that a transmission layer having higher transmission power than transmission power of a remaining (the other) transmission layer of the transmission layers is not used when the UL throughput of 2×2 UL MIMO communication at a given MCS level (e.g., MCS level 9 in Table 1 above) is less than or equal to the reference throughput. In the example illustrated in FIG. 7, the processor 410 (e.g., the second processor 410-2) may control the electronic apparatus 401 so that the first transmission layer is not used (or the first transmission path is deactivated) when the transmission power of the first transmission layer is greater than the transmission power of the second transmission layer (or when the transmission power of the first antenna 631 is greater than the transmission power of the second antenna 632). The processor 410 (e.g., the second processor 410-2) may control the transmission power of the second transmission layer (or the second antenna 632) to increase. In an embodiment, the processor 410 (e.g., the second processor 410-2) may instruct the RF communication circuit 420 (e.g., the RFFE 622) to increase the transmission power of the second transmission layer (or the second antenna 632) to the transmission power (e.g., TX power #2 described above) of the second transmission layer of the UL MIMO communication when determining the reference throughput, for example. The RF communication circuit 420 (e.g., the RFFE 622) may adjust (or increase) the gain of the second PA 622-1 so that the transmission power of the second transmission layer (or the second antenna 632) increases to the transmission power (e.g., TX power #2 described above) of the second transmission layer of the UL MIMO communication when determining the reference throughput.

In the example illustrated in FIG. 7, the processor 410 (e.g., the second processor 410-2) may transmit a baseband signal to the RFIC 610. Since the first transmission layer is not used (or the first transmission path is deactivated), the RFIC 610 may perform RF transform on the baseband signal to generate an RF signal and transmit the RF signal to the RFFE 622. The RFFE 622 may amplify the received RF signal through the second PA 622-1 and transmit the amplified RF signal to the second antenna 632. The second antenna 632 may transmit the amplified RF signal as a transmission signal to the base station 321. The second antenna 632 may transmit the transmission signal to the base station with increased transmission power (e.g., TX power #2 described above).

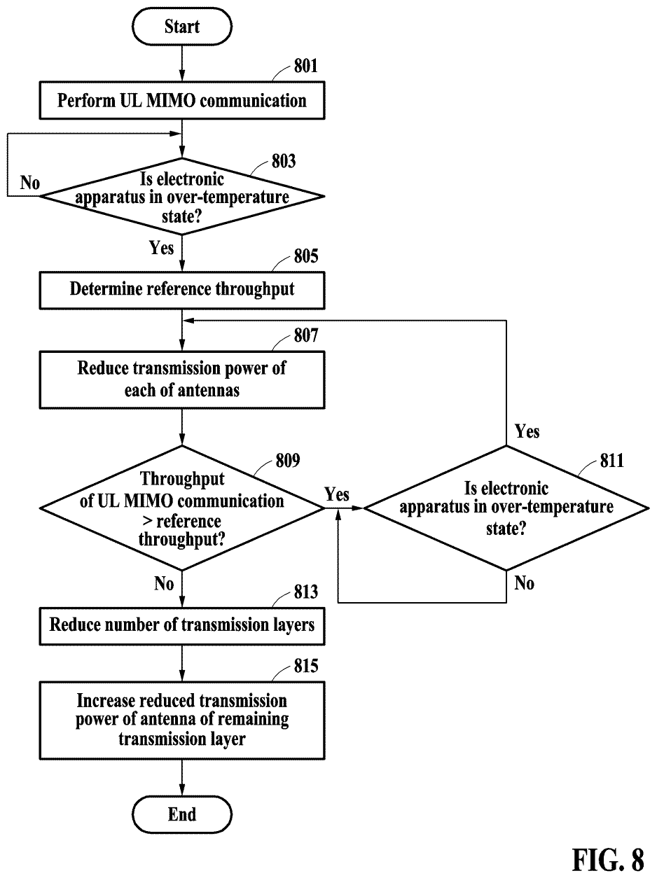

FIG. 8 is a flowchart illustrating an embodiment of an operating method of an electronic apparatus.

In operation 801, an electronic apparatus (e.g., the electronic apparatus 101 of FIG. 1, the electronic apparatus 201 of FIGS. 2A and 2B, the electronic apparatus 301 of FIG. 3, and the electronic apparatus 401 of FIG. 4) (hereinafter, also referred to as the electronic apparatus 401) may perform UL MIMO communication. In an embodiment, the electronic apparatus 401 may receive an MCS level (e.g., MCS level 18 in Table 1 above) from a base station (e.g., the base station 321 of FIG. 3). The electronic apparatus 401 may perform a processing operation on data to be transmitted to the base station 321 to generate a baseband signal, for example. The processing operation may include modulation according to a modulation scheme (e.g., 64-QAM) indicated by the received MCS level. The electronic apparatus 401 may perform RF transform on the generated baseband signal to generate a transmission signal of each transmission layer. The electronic apparatus 401 may transmit transmission signals to the base station 321 via antennas (e.g., the antennas 311 and 312 of FIG. 3 and the antennas 430 of FIG. 4) (or transmission layers). The electronic apparatus 401 may transmit a transmission signal of each transmission layer to the base station 321 via each of the antennas 430.

In operation 803, the electronic apparatus 401 may determine whether the electronic apparatus 401 is in an over-temperature state. In an embodiment, the electronic apparatus 401 (e.g., the processor 410) may estimate the temperature (e.g., surface temperature) of the electronic apparatus 401 based on a sensing value of one or more temperature sensors (e.g., one or more temperature sensors 440) (e.g., a sensing value obtained by one or more temperature sensors 440 measuring the internal temperature of the electronic apparatus 401) and may determine whether the estimated temperature exceeds a threshold temperature, for example. The electronic apparatus 401 may determine that the electronic apparatus 401 is in the over-temperature state when the estimated temperature exceeds the threshold temperature. The electronic apparatus 401 may determine that the electronic apparatus 401 is not in the over-temperature state when the estimated temperature is less than or equal to the threshold temperature.

The electronic apparatus 401 may perform operation 803 by periodically monitoring the temperature (e.g., surface temperature) of the electronic apparatus 401 when the electronic apparatus 401 is not in the over-temperature state (operation 803—No).

The electronic apparatus 401 may determine a reference throughput in operation 805 when the electronic apparatus 401 is in the over-temperature state (operation 803—Yes).

In an embodiment, the electronic apparatus 401 may determine the reference throughput based on the UL throughput of the UL MIMO communication at a given MCS level (e.g., MCS level 18 in Table 1 above). In an embodiment, the processor 410 (e.g., the second processor 410-2) may calculate the UL throughput of 2×2 UL MIMO communication at a given MCS level (e.g., MCS level 18 in Table 1 above) to be 157.42 Mbps, for example. The processor 410 (e.g., the second processor 410-2) may determine the throughput of one of the transmission layers of the 2×2 UL MIMO communication as the reference throughput or may determine a value obtained by adding an offset to the throughput of one of the transmission layers as the reference throughput. Half (e.g., 78.71 Mbps) of the UL throughput (e.g., 157.42 Mbps) of the 2×2 UL MIMO communication may correspond to the throughput of one of the transmission layers of the 2×2 UL MIMO communication. The processor 410 (e.g., the second processor 410-2) may determine, as the reference throughput, half (e.g., 78.71 Mbps) of the UL throughput (e.g., 157.42 Mbps) of the 2×2 UL MIMO communication or may determine a value obtained by adding an offset to half (e.g., 78.71 Mbps) as the reference throughput.

In an embodiment, the electronic apparatus 401 may store or record the transmission power value of each of the antennas 430 (or transmission layers) when the UL MIMO communication is performed (or when the reference throughput is determined) at a given MCS level (e.g., MCS level 18 in Table 1 above). In an embodiment, when the 2×2 UL MIMO communication is performed (or when the reference throughput is determined) at MCS level 18 and when the transmission power of the first antenna (e.g., the antenna 311 of FIG. 3) (or a first transmission layer) is TX power #3 and the transmission power of the second antenna (e.g., the antenna 312 of FIG. 3) (or a second transmission layer) is TX power #4, the processor 410 (e.g., the second processor 410-2) may store or record TX power #3 and TX power #4 in memory, for example.

In operation 807, the electronic apparatus 401 may reduce the transmission power of each of the antennas 430 (or transmission layers). To lower the temperature of the electronic apparatus 401, the electronic apparatus 401 may reduce (or back off) the transmission power of each of the antennas 430 (or transmission layers) by a predetermined value (e.g., 1 dB). In an embodiment, the processor 410 (e.g., the second processor 410-2) may control the electronic apparatus 401 to reduce the transmission power of the first antenna by 1 dB from TX power #3 and may control the electronic apparatus 401 to reduce the transmission power of the second antenna by 1 dB from TX power #4, for example.

At a given MCS level (e.g., MCS level 18 in Table 1 above), the electronic apparatus 401 may perform the UL MIMO communication with each transmission power reduced by performing operation 807. When receiving, from the electronic apparatus 401, the transmission signals, each having reduced transmission power, the base station 321 may transmit the changed MCS level (or relatively low MCS level) (e.g., an MCS level lower than MCS level 18) to the electronic apparatus 401. In an embodiment, the electronic apparatus 401 may receive the changed MCS level (e.g., MCS level 17 in Table 1 above) from the base station 321, for example. The electronic apparatus 401 may perform the UL MIMO communication at the changed MCS level (e.g., MCS level 17).

In operation 809, the electronic apparatus 401 may determine whether the throughput (or UL throughput) of the UL MIMO communication at the changed MCS level (e.g., MCS level 17 in Table 1 above) is greater than the reference throughput. In an embodiment, the processor 410 (e.g., the second processor 410-2) may calculate the UL throughput of the UL MIMO communication at the changed MCS level (e.g., MCS level 17 in Table 1 above) to be 147.54 Mbps, for example. The processor 410 (e.g., the second processor 410-2) may determine that the calculated UL throughput (e.g., 147.54 Mbps) is greater than the reference throughput (e.g., 78.71 Mbps or 78.71+offset Mbps).

The electronic apparatus 401 may repeatedly perform operations 811, 807, and 809 when the throughput (or UL throughput) of the UL MIMO communication at the changed MCS level is greater than the reference throughput (operation 809—Yes). By repeatedly performing operation 807, the base station 321 may receive, from the electronic apparatus 401, the transmission signals, each having reduced transmission power. As the transmission power of each of the transmission signals is reduced, the base station 321 may transmit, to the electronic apparatus 401, the changed MCS level (or relatively low MCS level) (e.g., an MCS level less than or equal to MCS level 16 in Table above).

By repeatedly performing operations 811, 807, and 809, the electronic apparatus 401 may receive the changed MCS level (or relatively low MCS level) (e.g., MCS level 9 in Table 1 above) from the base station 321. The electronic apparatus 401 may perform the UL MIMO communication at the changed MCS level (e.g., MCS level 9 in Table 1 above). The electronic apparatus 401 may check whether the UL throughput of the UL MIMO communication at the changed MCS level (e.g., MCS level 9 in Table 1 above) is greater than the reference throughput. In an embodiment, the processor 410 (e.g., the second processor 410-2) may calculate the UL throughput of the UL MIMO communication at the changed MCS level (e.g., MCS level 9 in Table 1 above) to be 78.7 Mbps, for example. The processor 410 (e.g., the second processor 410-2) may check that the calculated throughput (e.g., 78.7 Mbps) is less than the reference throughput (e.g., 78.71 Mbps or 78.71+offset Mbps).

The electronic apparatus 401 may reduce the number of transmission layers in operation 813 when the throughput (or UL throughput) of the UL MIMO communication at the changed MCS level (e.g., MCS level 9 in Table 1 above) is less than or equal to the reference throughput (operation 807—No). In an embodiment, the processor 410 (e.g., the second processor 410-2) may control the electronic apparatus 401 so that a transmission layer having higher transmission power than transmission power of a remaining (the other) transmission layer of the transmission layers of the UL MIMO communication is not used, for example. When the transmission power of the first transmission layer among the first and second transmission layers of 2×2 UL MIMO is greater than the transmission power of the second transmission layer, the processor 410 (e.g., the second processor 410-2) may control the electronic apparatus 401 so that the first transmission layer is not used.

In operation 815, the electronic apparatus 401 may increase the reduced transmission power of an antenna of a remaining transmission layer. In an embodiment, the processor 410 (e.g., the second processor 410-2) may perform control so that the first transmission layer among the first and second transmission layers of the 2×2 UL MIMO is not used, and thus the second transmission layer may be the remaining transmission layer, for example. The processor 410 (e.g., the second processor 410-2) may control the electronic apparatus 401 to increase the reduced transmission power of the second transmission layer (or the second antenna corresponding to the second transmission layer) to a transmission power value (e.g., TX power #4) of the second transmission layer (or the second antenna) among stored transmission power values (or transmission power values stored when the reference throughput is determined) (e.g., TX power #2 and TX power #4 described above). According to this control, the transmission power of the second transmission layer (or second antenna) may be increased to TX power #4. The electronic apparatus 401 may perform UL communication through the second transmission layer at the changed MCS level (e.g., MCS level 9 in Table 1 above). The base station 321 may receive a transmission signal with increased transmission power through the second transmission layer. The base station 321 may transmit the changed MCS level (or an increased MCS level) (e.g., an MCS level greater than or equal to MCS level 10 in Table 1 above) to the electronic apparatus 401. The electronic apparatus 401 may perform the UL communication through the second transmission layer at the changed MCS level (or increased MCS level).

In an embodiment, the instructions, when executed by at least one processor 410, may cause the electronic apparatus 401 to perform at least some (or all) of the operations described with reference to FIG. 8.

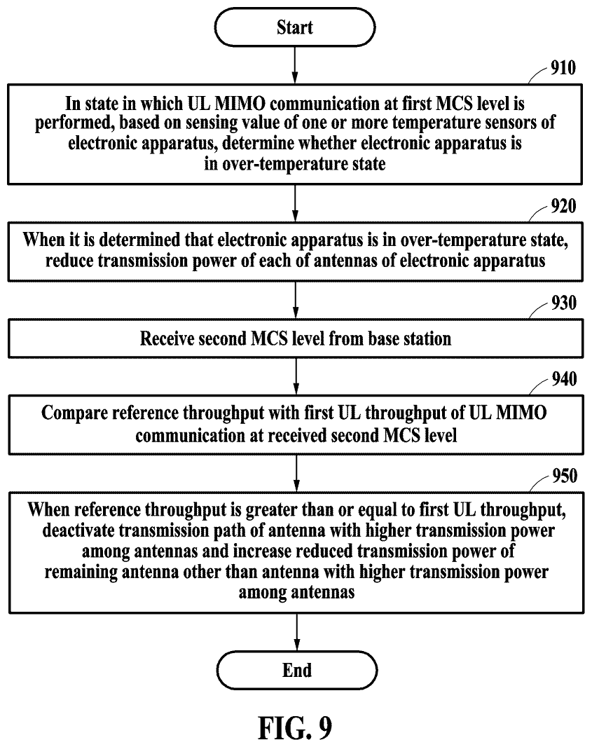

FIG. 9 is a flowchart illustrating an embodiment of an operating method of an electronic apparatus.

Referring to FIG. 9, in operation 910, an electronic apparatus (e.g., the electronic apparatus 101 of FIG. 1, the electronic apparatus 201 of FIGS. 2A and 2B, the electronic apparatus 301 of FIG. 3, and the electronic apparatus 401 of FIG. 4) (hereinafter, also referred to as the electronic apparatus 401) may determine whether the electronic apparatus 401 is in an over-temperature state based on a sensing value of one or more temperature sensors (e.g., the temperature sensor 440 of FIG. 4) of the electronic apparatus 401 in a state in which UL MIMO communication of a first MCS level is performed. The first MCS level may be, for example, one of the MCS levels in Table 1 above.

In an embodiment, the electronic apparatus 401 may estimate (or calculate) the temperature (e.g., surface temperature) of the electronic apparatus 401 based on the sensing value of one or more temperature sensors, and when the estimated temperature exceeds a threshold temperature, it may be determined that the electronic apparatus 401 is in the over-temperature state, for example.

In operation 920, when the electronic apparatus 401 determines that the electronic apparatus 401 is in the over-temperature state, the electronic apparatus 401 may reduce the transmission power of each of antennas (e.g., the antennas 430 of FIG. 4) of the electronic apparatus 401. In an embodiment, the electronic apparatus 401 may reduce the transmission power of each of the antennas 430 by a predetermined value (e.g., 1 dB), for example. The electronic apparatus 401 may transmit each of transmission signals to the base station 321 with each reduced transmission power.

In operation 930, the electronic apparatus 401 may receive a second MCS level from a base station (e.g., the base station 321 of FIG. 3). The second MCS level may have a lower level than the first MCS level. In an embodiment, the base station 321 may change the MCS level to the second MCS level when the transmission power of the electronic apparatus 401 is reduced and may transmit the second MCS level to the electronic apparatus 401, for example.

In operation 940, the electronic apparatus 401 may compare reference throughput with first UL throughput of the UL MIMO communication at the received second MCS level.

In operation 950, the electronic apparatus 401 may deactivate a transmission path of an antenna having higher transmission power than transmission power of a remaining (the other) antenna of the antennas 430 when the reference throughput is greater than or equal to the first UL throughput and may increase the reduced transmission power of a remaining antenna 430 other than the antenna having the higher transmission power.

In an embodiment, the electronic apparatus 401 may perform UL MIMO communication at a third MCS level before the UL MIMO communication at the first MCS level is performed. The third MCS level may have a higher level than the first MCS level, for example. The third MCS level may be, for example, an MCS level initially received by the electronic apparatus 401 from the base station 321. The electronic apparatus 401 may determine whether the electronic apparatus 401 is in an over-temperature state in a first state in which the UL MIMO communication at the third MCS level is performed. When determining that the electronic apparatus 401 is in the over-temperature state in the first state, the electronic apparatus 401 may store a transmission power value (e.g., TX power #1 and TX power #2 described with reference to FIG. 5 or TX power #3 and TX power #4 described with reference to FIG. 8) of each of the antennas 430 in the first state and reduce the transmission power of each of the antennas 430.

In an embodiment, the electronic apparatus 401 may determine the reference throughput based on second UL throughput of the UL MIMO communication at the third MCS level. In an embodiment, the electronic apparatus 401 may determine the reference throughput by dividing the second UL throughput by the number of antennas 430 (e.g., the number of antennas used for the UL MIMO communication) (or the number of transmission layers) or may determine the reference throughput by adding an offset to the calculated value, for example.

In an embodiment, the electronic apparatus 401 may increase the reduced transmission power of the remaining antenna (e.g., the second antenna 632 of FIG. 7) other than the antenna (e.g., the first antenna 631 of FIG. 7) having higher transmission power than transmission power of a remaining (the other) antenna of the antennas 430 to the transmission power of the transmission power value of the remaining antenna among stored transmission power values.

In an embodiment, the electronic apparatus 401 may determine whether the electronic apparatus 401 is in the over-temperature state while the UL MIMO communication at an MCS level indicating a first modulation scheme (e.g., 256-QAM) is performed. When determining that the electronic apparatus 401 is in the over-temperature state while the UL MIMO communication at the MCS level indicating the first modulation scheme is performed, the electronic apparatus 401 may repeatedly reduce the transmission power of each of the antennas 430 until the electronic apparatus 401 receives, from the base station 321, an MCS level indicating a second modulation scheme (e.g., 64-QAM) having a lower modulation order than the modulation order of the first modulation scheme.

In an embodiment, the instructions, when executed by at least one processor 410, may cause the electronic apparatus 401 to perform at least some (or all) of the operations described with reference to FIG. 9.

The embodiments described with reference to FIGS. 1 to 8 may apply to the operating method of the electronic apparatus of FIG. 9.

In an embodiment, an electronic apparatus 101, 201, 301, or 401 may include antennas 430, a temperature sensor 440, memory 450 storing instructions, and at least one processor 410 including processing circuitry.

The instructions, when executed by the at least one processor, may cause the electronic apparatus to perform, in a state in which UL MIMO communication at a first MCS level is performed, an operation of determining, based on a sensing value of the temperature sensor, whether the electronic apparatus is in an over-temperature state, when it is determined that the electronic apparatus is in the over-temperature state, an operation of reducing transmission power of each of the antennas, an operation of comparing reference throughput with first UL throughput of UL MIMO communication at a second MCS level received from a base station 321 when the reference throughput is greater than or equal to the first UL throughput, an operation of deactivating a transmission path of an antenna having higher transmission power than transmission power of a remaining (the other) antenna of the antennas, and an operation of increasing reduced transmission power of a remaining antenna other than the antenna having the higher transmission power.

In an embodiment, the instructions, when executed by the at least one processor, may cause the electronic apparatus to perform an operation of performing UL MIMO communication at a third MCS level before the UL MIMO communication at the first MCS level is performed and in a first state in which the UL MIMO communication at the third MCS level is performed, when the electronic apparatus is in the over-temperature state, an operation of storing a transmission power value of each of the antennas in the first state and reducing the transmission power of each of the antennas.

In an embodiment, the second processor may determine the reference throughput based on the second UL throughput of the UL MIMO communication at the third MCS level.

In an embodiment, the instructions, when executed by the at least one processor, may cause the electronic apparatus to perform an operation of determining a value calculated by dividing the second UL throughput by the number of antennas as the reference throughput or determining the reference throughput by adding an offset to the calculated value.

In an embodiment, the instructions, when executed by the at least one processor, may cause the electronic apparatus to perform an operation of increasing reduced transmission power of the remaining antenna to transmission power of a transmission power value for the remaining of the stored transmission power values.

In an embodiment, the instructions, when executed by the at least one processor, may cause the electronic apparatus to perform an operation of repeatedly reducing the transmission power of each of the antennas until an MCS level indicating a second modulation scheme having a lower modulation order than the modulation order of the first modulation scheme is received from the base station when the electronic apparatus is in the over-temperature state while UL MIMO communication at an MCS level indicating the first modulation scheme is performed.

In an embodiment, the first modulation scheme may include 256-QAM, and the second modulation scheme may include 64-QAM.

In an embodiment, the instructions, when executed by the at least one processor, may cause the electronic apparatus to perform, when the electronic apparatus is in the over-temperature state while the first UL throughput is greater than the reference throughput, an operation of further reducing the transmission power of each of the antennas.

In an embodiment, an electronic apparatus 101, 201, 301, or 401 may include antennas 430, a temperature sensor 440, memory 450 storing instructions, and at least one processor 410 including processing circuitry.

The instructions, when executed by the at least one processor, may cause the electronic apparatus to perform, in a state in which UL MIMO communication at a first MCS level is performed through transmission layers corresponding to the antennas, an operation of determining, based on a sensing value of the temperature sensor, whether the electronic apparatus is in an over-temperature state, when it is determined that the electronic apparatus is in the over-temperature state, an operation of reducing transmission power of each of the transmission layers, an operation of comparing reference throughput with first UL throughput of UL MIMO communication at a second MCS level received from a base station, and when the reference throughput is greater than or equal to the first UL throughput, an operation of reducing a number of transmission layers and increasing reduced transmission power of a remaining transmission layer.

In an embodiment, the operation of reducing the number of transmission layers may include an operation of reducing the number of transmission layers such that a transmission layer having higher transmission power than transmission power of a remaining (the other) transmission layer of the transmission layers is not used when the reference throughput is greater than or equal to the first UL throughput.

In an embodiment, the instructions, when executed by the at least one processor, may cause the electronic apparatus to perform an operation of performing UL MIMO communication at a third MCS level before the UL MIMO communication at the first MCS level is performed and when the electronic apparatus is in the over-temperature state in a first state in which the UL MIMO communication at the third MCS level is performed, an operation of storing a transmission power value of each of the transmission layers in the first state and reducing the transmission power of each of the transmission layers.

In an embodiment, the instructions, when executed by the at least one processor, may cause the electronic apparatus to perform an operation of determining the reference throughput based on second UL throughput of the UL MIMO communication at the third MCS level.

In an embodiment, the instructions, when executed by the at least one processor, may cause the electronic apparatus to perform an operation of determining a value calculated by dividing the second UL throughput by the number of transmission layers as the reference throughput or determining the reference throughput by adding an offset to the calculated value.

In an embodiment, the instructions, when executed by the at least one processor, may cause the electronic apparatus to perform an operation of increasing the reduced transmission power of the remaining transmission layer to transmission power of a transmission power value for the remaining transmission layer among the stored transmission power values.

In an embodiment, the instructions, when executed by the at least one processor, may cause the electronic apparatus to perform, when the electronic apparatus is in the over-temperature state while UL MIMO communication at an MCS level indicating a first modulation scheme is performed, an operation of repeatedly reducing the transmission power of each of the transmission layers until an MCS level indicating a second modulation scheme having a lower modulation order than a modulation order of the first modulation scheme is received from the base station.

In an embodiment, the first modulation scheme may include 256-QAM, and the second modulation scheme may include 64-QAM.

In an embodiment, the instructions, when executed by the at least one processor, may cause the electronic apparatus to perform, when the electronic apparatus is in the over-temperature state while the first UL throughput is greater than the reference throughput, an operation of reducing the transmission power of each of the transmission layers.

An operating method of an electronic apparatus 101, 201, 301, or 401 may include, in a state in which UL MIMO communication at a first MCS level is performed, based on a sensing value of one or more temperature sensors 440 of the electronic apparatus, determining whether the electronic apparatus is in an over-temperature state, when it is determined that the electronic apparatus is in the over-temperature state, reducing transmission power of each of antennas 430 of the electronic apparatus, receiving a second MCS level from a base station 321, comparing reference throughput with first UL throughput of UL MIMO communication at the received second MCS level, when the reference throughput is greater than or equal to the first UL throughput, deactivating a transmission path of an antenna having higher transmission power than transmission power of a remaining (the other) antenna of the antennas, and increasing reduced transmission power of a remaining antenna other than the antenna having the higher transmission power.

In an embodiment, the operating method may further include performing UL MIMO communication at a third MCS level before the UL MIMO communication at the first MCS level is performed, determining whether the electronic apparatus is in the over-temperature state in a first state in which the UL MIMO communication at the third MCS level is performed, and when the electronic apparatus is in the over-temperature state in the first state in which the UL MIMO communication at the third MCS level is performed, storing a transmission power value of each of the antennas in the first state and reducing transmission power of each of the antennas.

In an embodiment, the increasing of the reduced transmission power of the remaining antenna may include increasing the reduced transmission power of the remaining antenna among the antennas to transmission power of a transmission power value for the remaining antenna among the stored transmission power values.

What is claimed is:

1. An electronic apparatus comprising:
antennas;
a temperature sensor;
memory storing instructions; and
at least one processor comprising processing circuitry,
wherein the instructions, when executed by the at least one processor, cause the electronic apparatus to perform:
in a state in which uplink (UL) multiple-input and multiple-output (MIMO) communication at a first modulation and coding scheme (MCS) level is performed, an operation of determining, based on a sensing value of the temperature sensor, whether the electronic apparatus is in an over-temperature state;
when it is determined that the electronic apparatus is in the over-temperature state, an operation of reducing transmission power of each of the antennas;
an operation of comparing reference throughput with first UL throughput of UL MIMO communication at a second MCS level received from a base station;
when the reference throughput is greater than or equal to the first UL throughput, an operation of deactivating a transmission path of an antenna having a transmission power higher than transmission power of a remaining antenna of the antennas; and
an operation of increasing reduced transmission power of the remaining antenna other than the antenna having the transmission power.

2. The electronic apparatus of claim 1, wherein the instructions, when executed by the at least one processor, cause the electronic apparatus to perform:
an operation of performing UL MIMO communication at a third MCS level before the UL MIMO communication at the first MCS level is performed; and
in a first state in which the UL MIMO communication at the third MCS level is performed, when the electronic apparatus is in the over-temperature state, an operation of storing a transmission power value of each of the antennas in the first state and reducing the transmission power of each of the antennas.

3. The electronic apparatus of claim 2, wherein the instructions, when executed by the at least one processor, cause the electronic apparatus to perform, based on second UL throughput of the UL MIMO communication at the third MCS level, an operation of determining the reference throughput.

4. The electronic apparatus of claim 3, wherein the instructions, when executed by the at least one processor, cause the electronic apparatus to perform an operation of determining a value calculated by dividing the second UL throughput by a number of antennas as the reference throughput or determining the reference throughput by adding an offset to the calculated value.

5. The electronic apparatus of claim 2, wherein the instructions, when executed by the at least one processor, cause the electronic apparatus to perform an operation of increasing the reduced transmission power of the remaining antenna among the antennas to transmission power of a transmission power value for the remaining antenna among the stored transmission power values.

6. The electronic apparatus of claim 1, wherein the instructions, when executed by the at least one processor, cause the electronic apparatus to perform, when the electronic apparatus is in the over-temperature state while UL MIMO communication at an MCS level indicating a first modulation scheme is performed, an operation of repeatedly reducing the transmission power of each of the antennas until an MCS level indicating a second modulation scheme having a lower modulation order than a modulation order of the first modulation scheme is received from the base station.

7. The electronic apparatus of claim 1, wherein the instructions, when executed by the at least one processor, cause the electronic apparatus to perform, when the electronic apparatus is in the over-temperature state while the first UL throughput is greater than the reference throughput, an operation of further reducing the transmission power of each of the antennas.

8. An electronic apparatus comprising:
antennas;
a temperature sensor;
memory storing instructions; and
at least one processor comprising processing circuitry,
wherein the instructions, when executed by the at least one processor, cause the electronic apparatus to perform:
in a state in which uplink (UL) multiple-input and multiple-output (MIMO) communication at a first modulation and coding scheme (MCS) level is performed through transmission layers corresponding to the antennas, respectively, an operation of determining, based on a sensing value of the temperature sensor, whether the electronic apparatus is in an over-temperature state;
when it is determined that the electronic apparatus is in the over-temperature state, an operation of reducing transmission power of each of the transmission layers;
an operation of comparing reference throughput with first UL throughput of UL MIMO communication at a second MCS level received from a base station; and
when the reference throughput is greater than or equal to the first UL throughput, an operation of reducing a number of the transmission layers and increasing reduced transmission power of a remaining transmission layer remaining from the transmission layers.

9. The electronic apparatus of claim 8, wherein the operation of reducing the number of the transmission layers comprises an operation of reducing the number of the transmission layers in a manner that that a transmission layer having transmission power higher than transmission power of the remaining transmission layer of the transmission layers is not used when the reference throughput is greater than or equal to the first UL throughput.

10. The electronic apparatus of claim 8, wherein the instructions, when executed by the at least one processor, cause the electronic apparatus to perform:
an operation of performing UL MIMO communication at a third MCS level before the UL MIMO communication at the first MCS level is performed; and
when the electronic apparatus is in the over-temperature state in a first state in which the UL MIMO communication at the third MCS level is performed, an operation of storing a transmission power value of each of the transmission layers in the first state and reducing the transmission power of each of the transmission layers.

11. The electronic apparatus of claim 10, wherein the instructions, when executed by the at least one processor, cause the electronic apparatus to perform an operation of determining the reference throughput based on second UL throughput of the UL MIMO communication at the third MCS level.

12. The electronic apparatus of claim 11, wherein the instructions, when executed by the at least one processor, cause the electronic apparatus to perform an operation of determining a value calculated by dividing the second UL throughput by the number of the transmission layers as the reference throughput or determining the reference throughput by adding an offset to the calculated value.

13. The electronic apparatus of claim 10, wherein the instructions, when executed by the at least one processor, cause the electronic apparatus to perform an operation of increasing the reduced transmission power of the remaining transmission layer to transmission power of a transmission power value for the remaining transmission layer among the stored transmission power values.

14. The electronic apparatus of claim 8, wherein the instructions, when executed by the at least one processor, cause the electronic apparatus to perform, when the electronic apparatus is in the over-temperature state while UL MIMO communication at an MCS level indicating a first modulation scheme is performed, an operation of repeatedly reducing the transmission power of each of the transmission layers until an MCS level indicating a second modulation scheme having a lower modulation order than a modulation order of the first modulation scheme is received from the base station.

15. The electronic apparatus of claim 8, wherein the instructions, when executed by the at least one processor, cause the electronic apparatus to perform, when the electronic apparatus is in the over-temperature state while the first UL throughput is greater than the reference throughput, an operation of reducing the transmission power of each of the transmission layers.

16. The electronic apparatus of claim 6, wherein the first modulation scheme comprises 256-quadrature amplitude modulation (QAM) and the second modulation scheme comprises 64-QAM.

17. The electronic apparatus of claim 14, wherein the first modulation scheme comprises 256-quadrature amplitude modulation (QAM) and the second modulation scheme comprises 64-QAM.

18. An operating method of an electronic apparatus, the operating method comprising:
in a state in which uplink (UL) multiple-input and multiple-output (MIMO) communication at a first modulation and coding scheme (MCS) level is performed, based on a sensing value of a temperature sensor of the electronic apparatus, determining whether the electronic apparatus is in an over-temperature state;
when it is determined that the electronic apparatus is in the over-temperature state, reducing transmission power of each of antennas of the electronic apparatus;
comparing reference throughput with first UL throughput of UL MIMO communication at a second MCS level received from a base station;
when the reference throughput is greater than or equal to the first UL throughput, deactivating a transmission path of an antenna having transmission power higher than transmission power of a remaining antenna of the antennas; and
increasing reduced transmission power of the remaining antenna other than the antenna having the transmission power.

19. The operating method of claim 18, further comprising:
performing UL MIMO communication at a third MCS level before the UL MIMO communication at the first MCS level is performed;
determining whether the electronic apparatus is in the over-temperature state in a first state in which the UL MIMO communication at the third MCS level is performed; and
when the electronic apparatus is in the over-temperature state in the first state in which the UL MIMO communication at the third MCS level is performed, storing a transmission power value of each of the antennas in the first state and reducing transmission power of each of the antennas.

20. The operating method of claim 19, wherein the increasing of the reduced transmission power of the remaining antenna, among the antennas, other than the antenna having the transmission power comprises increasing the reduced transmission power of the remaining antenna among the antennas to transmission power of a transmission power value for the remaining antenna among the stored transmission power values.
